(19) United States
(12) Patent Application Publication
(10) Pub. No.: US 2004/0058262 A1
(43) Pub. Date: Mar. 25, 2004

(54) Toner and image forming method using the same and image forming apparatus

(75) Inventors: Manabu Serizawa, Minamiashigara-shi (JP); Kazuhiko Yanagida, Minamiashigara-shi (JP); Hidekazu Yaguchi, Minamiashigara-shi (JP); Takahisa Fujii, Minamiashigara-shi (JP); Yasuo Matsumura, Minamiashigara-shi (JP); Yasuo Kadokura, Minamiashigara-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/382,891

(22) Filed: Mar. 7, 2003

(30) Foreign Application Priority Data
Sep. 20, 2002 (JP) 2002-276099

(51) Int. Cl. G03G 9/087

(52) U.S. Cl. 430/108.4; 430/109.3; 430/111.4; 430/124

(57) ABSTRACT

The present invention provides a toner containing toner particles having a weight average molecular weight of 20,000 to 35,000. The toner is characterized in that upon using the toner to produce a 4.0 g/m² solid portion on a paper having a basis weight of 104 g/m², contacting the solid portion with a heating member of an image fixing device for 40 ms, and thereby fixing the solid portion on the paper, Gt(190)≧35% given that a glossiness of the solid portion when fixed at 190° C. according to JIS Z8741:97 is defined to be Gt(190), and 0.8≦Gt(180)/Gt(190)≦1.2 given that a glossiness of the solid portion when fixed at 180° C. is defined to be Gt(180).

### BACKGROUND OF THE INVENTION

1. Field of the Invention

The present invention relates to a toner preferably used for image formation in an electrophotography method, and the like, and an image forming method using the same.

2. Description of the Related Art

Nowadays, methods for visualizing image information via an electrostatic charged image such as an electrophotography method are widely used in various fields. According to the electrophotography method, an electrostatic charged image is developed on a photosensitive member via a charging step, an exposing step, and the like, and the electrostatic charged image is visualized via a transferring step, a fixing step, and the like.

According to the electrophotography method, an electrostatic charged image is developed onto a photosensitive member by a charging step, an exposing step, and the like, and the toner on the transfer member after the transferring step is melted by being heated by a heated heating member in the fixing step so as to be fixed on the surface of the transfer member. It is known that the toner cannot be fixed on the transfer member unless not only the toner but also the transfer member is heated to a necessary temperature by the heating member in the fixing step. Insufficient heating of the transfer member causes ″cold offset″ wherein only the toner is melted by being heated by the heating member and adheres to the heating member. Moreover, excess heating of the transfer member causes ″hot offset″ wherein the viscosity of the toner decreases so that a part or the entirety of the fixing layer adheres to the heating member. Therefore, there is a need to discover a fixing temperature range without the risk of the ″cold offset″ and the ″hot offset″ caused by being heated by the heating member.

Moreover, in the fixing step, and particularly when using a color toner, in addition to securing the fixing range, characteristics required at the time of fixing the toner include high glossiness of the image surface, high transparency, and the like. In the stage of melting and heating the toner, particles are adhered and integrated with each other and the image surface is smoothed so as to enhance the glossiness and the transparency. In the stage of further heating, the molten toner is permeated into the transfer member and the glossiness of the image surface declines because of the influence of the irregularity of the base material, the roughed surface caused by local viscosity decline of the resin on the image surface, and the like.

When using an ordinary color toner, the temperature at which the glossiness starts to enhance is higher than that of the “cold offset”, and the temperature at which the glossiness starts to decline is lower than that of ″hot offset″. Therefore, in general, the fixing temperature range for a color toner is narrower than that for a toner without the need of considering the glossiness and the transparency.

These days there is an increasing demand for energy saving and for a higher speed electrophotography method. The toner fixing temperature needs to be lowered to save the electric power in the fixing step that includes some electric power consumption, and to enlarge the fixing area. By lowering the toner fixing temperature, a high speed can be achieved in addition to the electric power saving and the fixing range enlargement. Furthermore, the so-called warm up time can be shortened and the life of the fixing roll can be prolonged. The warm up time means the waiting time until the fixing roll surface is warmed up to the temperature that enables fixing just after switching on the power source.

However, in order to lower the toner fixing temperature, toner particles having the lower glass transition point and a lower molecular weight should be employed. This will cause the glossiness decline when fixing at a high temperature, and it is hardly achieved together with a good toner storage property. It is necessary for a toner to have the so-called sharp melt property and a high viscosity so as to realize low temperature fixation, high glossiness in the fixation at a higher temperature, and a good toner storage property at the same time. The sharp melt property means that a toner with a high glass transition point shows a drastic viscosity decline at a high temperature range. A high viscosity means little toner viscosity declines in the fixation at a higher temperature. The toner having the sharp melt property has a low viscosity, and in contrast, the toner having a high viscosity does not have the sharp melt property, and thus these characteristics are generally incompatible with each other.

The Japanese Patent Application Laid-Open (JP-A) Nos. 5-158282 and 8-15909 disclose a method for narrowing the molecular weight distribution of a resin to provide the sharp melt property by a resin. Moreover, in general, the sharp melt property can be provided by a evening the composition of a resin, and the like, and an example using a polyester as the resin has been presented (for example, see JP-A No. 10-097098). Since a polyester resin is produced by the dehydration condensation of an acid component and an alcohol component as polymerizable monomers in the polymerization, the resin component is homogeneous. This is characteristics not provided in a vinyl based resin produced by the radical polymerization of a vinyl based monomer, represented by a styrene-acrylic resin. In the case of the vinyl based resin, in general, since the polymerization components differ in the polymerization initial stage and the polymerization final stage, the resin composition can easily be biased. Moreover, in the case of the vinyl based resin, for adjustment of the glass transition temperature (hereinafter abbreviated as Tg), and the like, a polymerizable monomer having a relatively large side chain with respect to the resin principal chain needs to be used, so that it is characteristic thereof that the polymerized resin tends to be vulnerable.

However, in general, in case of a toner using a polyester resin, charging control tend to be difficult, and thus there arises a problem that the charging amount largely alters particularly between the summer and the winter environment. In order to solve the problem, for example, JP-A No. 5-333699 discloses a method for controlling the charging amount according to a toner concentration by mounting a sensor in a developing machine. However, it is not preferable in that the developing machine becomes larger due to the installation of the controlling device. On the other hand, the charging control is easy in the case of the vinyl based resin such as a styrene-acrylic, but there are problems in the present situation as mentioned above.

In the fixing step for fixing the toner, in general, a transfer member on which an unfixed toner image has been transferred in a transferring step is inserted between heated metal rolls together with the transfer member, whereby the unfixed toner is heated and melted so as to be fixed on the transfer member. At the time, a method of adhering a silicone rubber, a baiton rubber, and the like on the surface of at least one of the metal rolls is applied for the purpose of prolonging the heating time to the unfixed toner, or restraining or preventing the strange noise generated by collision between the rolls in the fixation, abrasion and deformation of the metal rolls, and the like. Since in general heat conduction of rubber is lower than that of metal, this method can solve the problem in the case of using the metal rolls, though the heat generation amount necessary for heating the roll surface to a desired temperature increases. Furthermore, this method is generally applied because of the advantage that a mold releasing agent such as a silicone oil can be permeated to the rubber surface to give a high mold releasing property with respect to the toner.

Moreover, since a larger amount of heat supply to the unfixed toner is necessary in the case of using a color toner, a method of mounting a heating device on the both rolls through which a transfer member passes is generally employed.

However, according to this fixing device, a component for supplying an oil is needed so that miniaturization can hardly be achieved and the energy saving cannot be realized. Furthermore, the mold releasing agent is permeated on the surface in the fixed image after fixation by this fixing device, which may cause some problems, namely, overwriting with a water based ink of for example a ball-point pen is not possible, and a trouble of image unevenness due to the residual mold releasing agent on the film happens in the case of fixing onto a film.

In order to solve this problem, a method of adding a mold releasing agent such as a wax to a toner and at the same time processing a resin with a high peeling property such as a fluorine-containing resin on the fixing roll surface is disclosed (for example, see JP-A Nos. 6-67504 or 9-106105). According to this method, since the oil supplying machine of the fixing device can be removed, miniaturization can be achieved. However, in order to realize the high glossiness using a color toner, the toner needs to have a low viscosity as mentioned above. In that case, the peeling performance can easily be deteriorated due to decline of the aggregation force between the resin molecules, and thus consequently there arises a problem that the “hot offset” can easily occur.

Furthermore, in order to solve these problems, a method for obtaining a high fixation range by containing a gel component is discussed (for example, see JP-A No. 5-341564). However, by containing a gel component, the glossiness and the transparency are lowered at the same time.

Moreover, in addition to the demand for the higher speed, there is a high demand for a toner and an image forming method providing the high glossiness even in the case of using wide range of papers, particularly a paper with a high basis weight. An increase in the paper basis weight generally leads to an increase in the heat absorption amount of the paper per a unit area. Thus the ratio of the heat amount needed for the toner fixation is lowered. As a result, at the same fixing temperature, the glossiness declines according to the increase in the paper basis weight, and thus it is not preferable in the case of using a color toner. For restraining the glossiness decline, there are several resolutions such as raising the fixing temperature, increasing the contact time of the fixing member and the toner. However, the low temperature fixing property cannot be achieved in the former case. In the latter case, as the method for increasing the contact time, there are a method of lowering the processing speed and of lowering the hardness of the fixing member such as heating rolls. However, according to the method of lowering the processing speed, a high speed cannot be achieved, and according to the method of lowering the hardness of the fixing member such as heating rolls, the life of the material of the fixing member is shortened, and thus neither is preferable.

Recently, as means for producing a toner with a particle shape and a surface composition controlled intentionally, a emulsion polymerization aggregating method has been proposed (for example, see JP-A Nos. 63-282752 or 6-250439). The emulsion polymerization aggregating method is a method for obtaining toner particles by producing a resin dispersion by emulsion polymerization and a coloring agent dispersion by dispersing a coloring agent in a solvent, mixing the resin dispersion and the coloring agent dispersion to form aggregated particles corresponding to the toner particle size, and heating for fusion. According to this emulsion polymerization aggregating method, the toner shape can be controlled at discretion from the amorphous shape to the spherical shape by selecting the heating temperature condition.

Furthermore, for example, JP-A Nos. 8-044111 and 8-286416 have proposed a suspension polymerization method of producing a toner by dispersing and suspending a polymerization monomer in a water based medium together with a coloring agent, a mold releasing agent, and the like, and polymerizing them thereafter, and a production method of a toner having a multiple layer structure in which wax as a mold releasing agent is wrapped in a binder resin.

According to these methods, since the particle distribution of the toner particles to be produced can be made narrower, a high image quality can be achieved. At the same time, since a toner of a low molecular weight range and/or a high molecular weight range, which has not been achieved by the conventional kneading pulverization method, can be produced, the freedom of material choice for the toner can be wider, which it is advantageous.

Moreover, for example, JP-A No. 2000-250258 has proposed a method for obtaining a high quality image by controlling the glossiness unevenness at the time of the fixation by limiting the change ratio of the glossiness with respect to the temperature.

However, according to this method, it is necessary to produce a stable dispersion state of the polymerizable monomer in a water based medium. Although there is a method of adding a small amount of a surfactant and an organic/inorganic acid for that purpose, the charging control becomes difficult by adding the surfactant, and the washing step also becomes complicated, and thus it is not preferable. In the case the organic/inorganic acid is added, the acid tends to remain on the interface after the polymerization, thus the Tg in the vicinity of the toner surface rises, and consequently the Tg of the entire toner rises, which causes the glossiness decline in the fixation, and thus it is not preferable.

Therefore, there is an increasing demand for a toner and an image forming method, which realizes a balance of high image quality, high glossiness and high speed.

### SUMMARY OF THE INVENTION

An object of the present invention is to provide a toner capable of maintaining the high glossiness of a fixed image even in the case of using a paper with a high basis weight and executing the image fixation at a high speed, and capable of restraining generation of the glossiness unevenness, and an image forming method using the same.

Specifically, the present invention which attains the above-mentioned object is as follows.

A first embodiment of the invention provides a toner containing toner particles having 20,000 to 35,000 weight average molecular weight, containing a binder resin synthesized using a polymerizable monomer having a carboxyl group and a vinyl based unsaturated double bond, and a polymerizable monomer having a vinyl based unsaturated double bond, wherein, upon using the toner to produce a 4.0 g/m² solid portion on a paper having a basis weight of 104 g/m², contacting the solid portion with a heating member of an image fixing device for 40 ms, and thereby fixing the solid portion on the paper, Gt(190)≧35% given that a glossiness of the solid portion when fixed at 190° C. according to JIS Z8741:97 is defined to be Gt(190), and 0.8≦Gt(180)/Gt(190)≦1.2 given that a glossiness of the solid portion when fixed at 180° C. is defined to be Gt(180).

A second embodiment of the invention provides a toner according to the first embodiment, wherein the weight average molecular weight of the toner particles is 25,000 to 32,000.

A third embodiment of the invention provides a toner according to the first embodiment, wherein the weight average molecular weight of the toner particles is 28,000 to 32,000.

A fourth embodiment of the invention provides a toner according to the first embodiment, wherein the content of the polymerizable monomer having a carboxyl group and a vinyl based unsaturated double bond in the binder resin is 0.3 to 10% by mass based on the total amount of the polymerizable monomers.

A fifth embodiment of the invention provides a toner according to the first embodiment, wherein the content of the polymerizable monomer having a carboxyl group and a vinyl based unsaturated double bond in the binder resin is 0.5 to 6% by mass based on the total amount of the polymerizable monomers.

A sixth embodiment of the invention provides a toner according to the first embodiment, wherein the content of the polymerizable monomer having a carboxyl group and a vinyl based unsaturated double bond in the binder resin is 1 to 3% by mass based on the total amount of the polymerizable monomers.

A seventh embodiment of the invention provides a toner according to the first embodiment, wherein an absolute value of a charging amount of the toner is 10 to 40 μC/g.

An eighth embodiment of the invention provides a toner according to the first embodiment, wherein an absolute value of a charging amount of the toner is 15 to 35 μC/g.

A ninth embodiment of the invention provides a toner according to the first embodiment, formed by an emulsion polymerization aggregating method.

A tenth embodiment of the invention provides a toner according to the first embodiment, formed by a suspension polymerization method.

An eleventh embodiment of the invention provides a toner according to the first embodiment, containing one or more kinds of peeling agents.

A twelfth embodiment of the invention provides a toner according to the eleventh embodiment, wherein the molecular weight of the peeling agent is 300 to 2,000.

A thirteenth embodiment of the invention provides a toner according to the eleventh embodiment, wherein the molecular weight of the peeling agent is 500 to 1,500.

A fourteenth embodiment of the invention provides a toner according to the eleventh embodiment, wherein the molecular weight of the peeling agent is 600 to 1,300.

A fifteenth embodiment of the invention provides a toner according to the eleventh embodiment, containing a carboxylic acid or a derivative thereof.

A sixteenth embodiment of the invention provides an image forming method comprising an electrostatic latent image forming step for forming an electrostatic latent image on an image supporting member according to image information, an image forming step for visualizing the electrostatic latent image as a toner image with a developing agent, a transferring step for transferring the toner image on a transfer member, and a fixing step for fixation by inserting the transfer member with the toner image transferred between a heating member and a pressuring member of an image fixing device, wherein the developing agent contains the toner according to the first embodiment.

A seventeenth embodiment of the invention provides an image forming method according to the sixteenth embodiment, wherein the surface of the heating member is coated with a fluorine-containing resin.

An eighteenth embodiment of the invention provides an image forming method according to the sixteenth embodiment, wherein the pressuring member comprises a resin film.

A nineteenth embodiment of the invention provides an image forming method according to the sixteenth embodiment, wherein the surface temperature of the heating member is 170° C. or greater.

A twentieth embodiment of the invention provides an image forming method according to the sixteenth embodiment, wherein the surface temperature of the heating member is 180° C. or greater.

A twenty-first embodiment of the invention provides an image forming method according to the sixteenth embodiment, wherein the transfer member is a paper having a basis weight of 104±5 g/m².

A twenty-second embodiment of the invention provides an image forming apparatus comprising a device for visualizing the electrostatic latent image as a toner image with a developing agent, wherein the developing agent contains the toner according to the first embodiment.

### DESCRIPTION OF THE PREFERRED EMBODIMENTS

A toner of the present invention contains toner particles having weight average molecular weight of 20,000 to 35,000, containing a binder resin synthesized using a polymerizable monomer having a carboxyl group and a vinyl based unsaturated double bond, and a polymerizable monomer having a vinyl based unsaturated double bond. The toner is characterized in that upon using the toner to produce a 4.0 g/m² solid portion on a paper having a basis weight of 104 g/m², contacting the solid portion with a heating member of an image fixing device for 40 ms, and thereby fixing the solid portion on the paper, Gt(190)≧35% given that a glossiness of the solid portion when fixed at 190° C. according to JIS Z8741:97 is defined to be Gt(190), and 0.8≦Gt(180)/Gt(190)≦1.2 given that a glossiness of the solid portion when fixed at 180° C. is defined to be Gt(180).

In general, the glossiness of the toner for the heating fixation is determined by the thermal characteristics of the binder resin. The toner as particles is developed to a latent image on the photosensitive member in the image forming step so as to be transferred onto the transfer member via the transferring step. In the fixing step, the toner on the transfer member is inserted between the heating member and the pressuring member together with the transfer member to be melted for fixation. The melted state at the time of the fixation as well as the glossiness can easily be influenced by the fixing condition at the time. As mentioned above, the glossiness tends to be further lowered due to increase in the basis weight of the transfer member (paper), decline of the contact time with the heating member due to realization of the higher speed, addition of a high Tg component to the binder resin, and the like.

As the high Tg component, a polymerizable monomer having a carboxyl group and a vinyl based unsaturated double bond is employed in the invention. It is convenient for maintaining the dispersion stability in the dispersing step in the water based medium of the emulsion polymerization, the suspension polymerization, and the like. This is because a part of the carboxyl group is arranged in the water based medium direction, and a part of the vinyl based unsaturated double bond is arranged in the polymerizable monomer direction so as to increase the dispersion stability. As a result of the polymerization in this state, the carboxyl group is arranged more on the synthesized binder resin surface, and therefore, the Tg on the binder resin surface tends to be higher than that inside the binder resin. Therefore, the Tg of the toner as a whole is raised, and the fixing property of the toner, in particular, the glossiness is lowered.

The molecular weight of the toner influences the fixing characteristic as well. In general, the glossiness of the fixed image is in the contradictory relationship with respect to the toner molecular weight. In order to obtain the high glossiness, a smaller molecular weight is preferable. However, the case of a small molecular weight has such problems that the fixed image tends to be vulnerable, that the ″hot offset″ can easily occur, and the like. Therefore, the weight average molecular weight of the toner particles according to the invention is 20,000 to 35,000. It is preferably 25,000 to 32,000, and more preferably 28,000 to 32,000. In the case the weight average molecular weight of the toner particles is less than 20,000, the glossiness decline, the “hot offset”, and the like can easily occur due to permeation of the fixed image. In the case it is more than 35,000, the glossiness is lowered.

Moreover, since the toner of the invention satisfies the condition that upon using the toner to produce a 4.0 g/m² solid portion on a paper having a basis weight of 104 g/m², contacting the solid portion with a heating member of an image fixing device for 40 ms, and thereby fixing the solid portion on the paper, Gt(190)≧35% given that a glossiness of the solid portion when fixed at 190° C. according to JIS Z8741:97 is defined to be Gt(190), and 0.8≦Gt(180)/Gt(190)≦1.2 given that a glossiness of the solid portion when fixed at 180° C. is defined to be Gt(180), the high glossiness can be maintained at the time of the fixation, and at the same time, the quality decline generated due to the glossiness decline at the time of continuous paper passage can be reduced.

In the case the Gt(190) is less than 35%, the glossiness decline becomes remarkable due to the heat absorption by the paper so that the glossiness decline that varies between the papers can apparently be recognized visibly. Therefore, there arises a problem that the fixed image lacks the reliability remarkably.

In the case of fixing the toner by heating and melting, most of the amount of the heat of the heating member surface is deprived by the paper. In the case of a paper with a high basis amount, the ratio further increases. Particularly in the case heating is applied in a high speed, the surface temperature of the heating member needs to be high to some extent in order to melt the toner and provide the glossiness to certain degree. In the case of the image forming method of the invention, the surface temperature of the heating member is preferably 170° C. or greater, more preferably 180° C. or greater so that a fixed image having the glossiness can be obtained. In the case a toner having the glossiness at less than 170° C. is used, although the fixing property at a low temperature is provided, the storage property of the fixed image is not provided. In the case of fixing at 200° C. or more, not only the electric power consumption increases but also deterioration of the image fixing device due to heat can easily be generated, and thus it is not preferable.

In the case the Gt(180)/Gt(190) is less than 0.8, the glossiness can easily be influenced by the temperature, so that the glossiness in a fixed image can easily be fluctuated, and thus it is not preferable. Moreover, in the case the Gt(180)/Gt(190) is more than 1.2, not only the glossiness in a fixed image can easily be fluctuated as mentioned above but also the toner viscosity is excessively lowered in a high temperature condition, so that the so-called “hot offset” can easily occur, and thus it is not preferable.

The polymerizable monomer having a carboxyl group and a vinyl based unsaturated double bond as the material of the binder resin contained in the toner particles according to the present invention is not particularly limited. However, examples thereof include monocarboxylic acids such as an acrylic acid, a methacrylic acid, a cinnamic acid, a crotonic acid, and a sorbic acid; polymers thereof; and polyvalent carboxylic acids such as a fumaric acid, an itaconic acid, a maleic acid, a trans-aconitic acid, and a tetrahydro phthalic acid. A monomer having a plurality of vinyl groups may be used as well.

Among these examples, from the viewpoint of easy polymerization with another polymerizable monomer and the dispersion stability, an acrylic acid and a methacrylic acid are preferable.

The polymerizable monomer having a vinyl based unsaturated double bond as the material of the binder resin contained in the toner particles according to the invention is not particularly limited as long as it is a monomer capable of having the radical polymerization reaction with the polymerizable monomer having the carboxyl group and the vinyl based unsaturated double bond. The examples thereof include styrenes such as a styrene, parachloro styrene and an a-methyl styrene; esters having a vinyl group such as a methyl acrylate, an ethyl acrylate, an n-propyl acrylate, an n-butyl acrylate, a lauryl acrylate, a 2-ethyl hexyl acrylate, a methyl methacrylate, an ethyl methacrylate, an n-propyl methacrylate, a lauryl methacrylate and a 2-ethyl hexyl methacrylate; vinyl nitriles such as an acrylonitrile and a methacrylonitrile; vinyl ethers such as a vinyl methyl ether and a vinyl isobutyl ether; vinyl ketones such as a vinyl methyl ketone, a vinyl ethyl ketone and a vinyl isopropenyl ketone; and olefins such as an ethylene, a propylene, a butadiene and an isoprene. A monomer having a plurality of vinyl groups may be used as well.

Among these examples, for the advantages such as the close contact property with a paper, the resin transparency and the charge controlling property, the styrenes, the esters having a vinyl group, and a homopolymer or a copolymer of a butadiene are preferable, and a styrene, a methyl acrylate, an ethyl acrylate, an n-propyl acrylate, an n-butyl acrylate, a lauryl acrylate, a methyl methacrylate, an ethyl methacrylate, and an n-propyl methacrylate are more preferable.

The polymerizable monomers may be used alone or in a combination of two or more kinds.

The binder resin according to the invention, synthesized using the polymerizable monomer having the carboxyl group and the vinyl based unsaturated double bond, and the polymerizable monomer having the vinyl based unsaturated double bond is not particularly limited. However, examples thereof include a styrene-acrylic acid n-butyl-acrylic acid copolymer based resin, a methyl acrylate-n-butyl acrylate-acrylic acid copolymer based resin, and the like.

The content of the polymerizable monomer having a carboxyl group and a vinyl based unsaturated double bond used in the invention in the binder resin is preferably 0.3 to 10% by mass based on the total amount of the polymerizable monomers, it is more preferably 0.5 to 6% by mass, and it is further preferably 1 to 3% by mass.

It is preferable that the toner particles according to the invention are formed by the emulsion polymerization aggregating method using binder resin particles having a 1 μm or less particle size, or the suspension polymerization method.

The emulsion polymerization aggregating method includes a step of forming aggregated particles by mixing a resin particle dispersion in which binder resin particles of 1 micron or less synthesized by the emulsion polymerization, or the like, are dispersed and a coloring agent dispersion (hereinafter also referred to as the ″aggregation step″), and a step of forming toner particles by heating the aggregated particles to a temperature of the glass transition point of the binder resin or more for fusion (hereinafter also referred to as the ″fusing step″).

In the aggregation step, the resin particle dispersion, the coloring agent dispersion, and, as needed, a mold releasing agent dispersion are mixed with each other, and the components contained therein aggregate so as to form the aggregated particles. The aggregated particles are formed by the hetero aggregation, and the like. The aggregated particles are formed by adding an ionic surfactant having the polarity different from that of the aggregated particles, or a compound having the monovalent or more charge, such as a metal salt for the purpose of stabilization of the aggregated particles, and control of the particle size/particle size distribution.

In the aggregation step, the aggregated particles can be adjusted by generating aggregation by the pH change. Moreover, an aggregating agent may be added to any of dispersions in order to aggregate the particles stably and quickly, and furthermore to obtain the aggregated particles having a narrower particle size distribution.

As the aggregating agent, a compound having the monovalent or more charge is preferable. The specific examples of the compound having the monovalent or more charge as the aggregating agent include water soluble surfactants such as an inonic surfactant and a nonionic surfactant to be described later, acids such as a hydrochloric acid, a sulfuric acid, a nitric acid, an acetic acid and an oxalic acid, metal salts of an inorganic acid such as a magnesium chloride, a sodium chloride, an aluminum sulfate, a calcium sulfate, an ammonium sulfate, an aluminum nitrate, a silver nitrate, a copper sulfate and a sodium carbonate, aliphatic acids such as a sodium acetate, a potassium formate, a sodium oxalate, a sodium phthalate and a potassium salicylate, metal salts of phenols such as a metal salt of an aromatic acid and a sodium phenolate, inorganic acid salts of aliphatic or aromatic amines such as a metal salt of an amino acid, a triethanol amine hydrochloride and an aniline hydrochloride, inorganic acid salts such as aromatic amines, and the like.

Among these examples, in consideration of the stability of the aggregated particles, the stability with respect to heat or elapsed time of the aggregating agent, and the elimination easiness at the time of washing, the metal salts of an inorganic acid are preferable in terms of the performance and use.

The amount of the aggregating agent added to any of dispersions differs depending on the number of valences of the charge. In the case of the monovalence, it is preferably 3% by mass or less, in the case of the divalence, it is preferably 1% by mass or less, and in the case of the trivalence, it is preferably 0.5% by mass or less. Since a smaller amount of the aggregating agent is better, a compound with a large number of valences of the charge is preferable.

In the fusing step, the binder resin in the aggregating particles is fused in the temperature condition of the glass transition point or higher so as to form toner particles.

In the suspension polymerization method, toner particles are formed by suspending coloring agent particles and mold releasing agent particles or the like in a water based medium to which the polymerizable monomer and, as needed, a dispersion stabilizing agent or the like are added so as to be dispersed to a desired particle size and a particle size distribution, polymerizing the polymerizable monomer by means of heating or the like, separating the polymerization product from the water based medium after the polymerization reaction, and washing and drying as needed.

As the dispersion stabilizing agent used in the suspension polymerization method, hardly water soluble and hydrophilic inorganic fine powders may be used. The usable inorganic fine powders include, a silica, an alumina, a titania, a calcium carbonate, a magnesium carbonate, a tricalcium phosphate (hydroxy apatite), a clay, a diatomaceous earth, a bentonite, and the like. Among these examples, a calcium carbonate, a tricalcium phosphate, and the like are preferable for easiness in particle formation of the fine particle and easiness in elimination.

Moreover, a water based polymer, which is solid in an ordinary temperature, and the like can be used as well. Specifically, cellulose based compounds such as a carboxy methyl cellulose, and a hydroxy propyl cellulose, a polyvinyl alcohol, a gelatin, a starch, a gum Arabic, and the like can be used.

A surfactant may be used for the purpose of stabilization at the time of dispersion in the suspension polymerization method, and dispersion stability of a resin particle dispersion, a coloring agent dispersion and a mold releasing agent dispersion in the emulsion polymerization aggregating method.

The examples of the surfactant include anionic surfactants such as a sulfate based one, a sulfonate based one, a phosphate ester based one, and a soap based one; cationic surfactants such as an amine salt type, and a quaternary ammonium salt type; nonionic surfactants such as a polyethylene glycol based one, an alkyl phenol ethylene oxide adduct based one, and a polyhydric alcohol based one, and the like. Among these examples, the anionic surfactants and the cationic surfactants are preferable.

According to the toner of the invention, since the anionic surfactants in general have a strong dispersion force so as to serve excellently for dispersion of the binder resin particles and the coloring agent, the cationic surfactants are advantageous as the surfactant for dispersing the mold releasing agent.

It is preferable that the nonionic surfactant is used in combination with the anionic surfactant or cationic surfactant. The surfactants may be used alone or in a combination of two or more kinds.

The specific examples of the anionic surfactants include fatty acid soaps such as a potassium laurate, a sodium oleate, and a sodium castor oil; sulfates such as an octyl sulfate, a lauryl sulfate, a lauryl ether sulfate, and a nonyl phenyl ether sulfate; sodium alkyl naphthalene sulfonates such as a lauryl sulfonate, a dodecyl benzene sulfonate, a triisopropyl naphthalene sulfonate and a dibutyl naphthalene sulfonate, a naphthalene sulfonate formalin condensation product, sulfonates such as a monooctyl sulfosuccinate, a dioctyl sulfosuccinate, an amido laurate sulfonate, and an amido oleate sulfonate; phosphates such as a lauryl phosphate, an isopropyl phosphate, and a nonyl phenyl ether phosphate; dialkyl sulfo succinic acid salts such as a sodium dioctyl sulfo succinate, sulfo succinic acid salts such as a disodium lauryl sulfosuccinate; and the like.

Among these examples, the fatty acid soaps, the sulfates and the sulfonates are preferable due to the advantage in terms of the high dispersion force and the solubility to water. In particular, a sodium dodecyl benzene sulfonate, a sodium oleate and a lauryl sulfate are preferable.

The specific examples of the cationic surfactant include amine salts such as a lauryl amine hydrochloride, a stearyl amine hydrochloride, an oleyl amine acetate, a stearyl amine acetate, and a stearyl amino propyl amine acetate; quaternary ammonium salts such as a lauryl trimethyl ammonium chloride, a dilauryl dimethyl ammonium chloride, a distearyl ammonium chloride, a distearyl dimethyl ammonium chloride, a lauryl dihydroxy ethyl methyl ammonium chloride, an oleyl bispolyoxy ethylene methyl ammonium chloride, a lauroyl amino propyl dimethyl ethyl ammonium ethosulfate, a lauroyl amino propyl dimethyl hydroxyl ethyl ammonium perchlorate, an alkyl benzene dimethyl ammonium chloride and an alkyl trimethyl ammonium chloride; and the like.

Among these examples, a lauryl amine hydrochloride, a stearyl amine hydrochloride, an oleyl amine acetate and a stearyl amine acetate are preferable due to the advantage in terms of the aggregating property and the charging property. In particular, lauryl amine hydrochloride and a stearyl amine hydrochloride are preferable.

The specific examples of the nonionic surfactants include alkyl ethers such as a polyoxy ethylene octyl ether, a polyoxy ethylene lauryl ether, a polyoxy ethylene steary ether and a polyoxy ethylene oleyl ether; alkyl phenyl ethers such as a polyoxy ethylene octyl phenyl ether and a polyoxy ethylene nonyl phenyl ether; alkyl esters such as a polyoxy ethylene laurate, a polyoxy ethylene stearate, and a polyoxy ethylene oleate; alkyl amines such as a polyoxy ethylene lauryl amino ether, a polyoxy ethylene stearyl amino ether, a polyoxy ethylene oleyl amino ether, a polyoxy ethylene soy bean amino ether, and a polyoxy ethylene beef tallow amino ether; alkyl amides such as a polyoxy ethylene amide laurate, a polyoxy ethylene amide stearate, and a polyoxy ethylene amide oleate; plant oil ethers such as a polyoxy ethylene castor oil ether, and a polyoxy ethylene rape seed oil ether; alkanol amides such as a diethanol amide laurate, a diethanol amide stearate, and a diethanol amide oleate; sorbitan ester ethers such as a polyoxy ethylene sorbitan monolaurate, a polyoxy ethylene sorbitan monopermeate, a polyoxy ethylene sorbitan monostearate, and a polyoxy ethylene sorbitan monooleate; and the like.

Among these examples, alkyl ethers; alkyl phenyl ethers and alkyl esters are preferable due to the advantage in the charge controlling property and the dispersion stability in the low temperature range. In particular, a polyoxy ethylene octyl phenol ether, a polyoxy ethylene nonyl phenyl ether, a polyoxy ethylene octyl ether, a polyoxy ethylene lauryl ether, and a polyoxy ethylene stearyl ether are preferable.

The content of the surfactant in any of dispersions may be to a degree not to hinder the effect of the invention. In general, it is a small amount. Specifically, it is 0.01% by mass to 10% by mass. More preferably it is 0.05 to 5% by mass, and further preferably it is 0.1 to 2% by mass. In the case the content is less than 0.01% by mass, each dispersion such as the resin particle dispersion, the coloring agent dispersion, the mold releasing agent dispersion, and the like becomes unstable so as to cause the problems of generating aggregation, or generating liberation of specific particles due to difference of the stability of the particles at the time of aggregation, and the like. In the case it is more than 10% by mass, the particle size distribution of the particles becomes wide, which leads to the difficulty in the particle size control, and thus it is not preferable. In general, the suspension polymerization toner dispersion having a large particle size can be stable with a small use amount of the surfactant.

According to the suspension polymerization method, a viscosity adjusting agent may further be included in the water based medium for adjusting the particle size and the particle size distribution. The examples of the viscosity adjusting agent include a glycerol, an ethylene glycol, a diethylene glycol, a triethylene glycol, a polyethyle glycol, and the like. It is preferable to include the viscosity adjusting agent in a range of 1.0 to 50% by mass.

To the binder resin according to the invention, a cross-linking agent may be added if necessary. The specific examples of the cross-linking agent include aromatic polyvinyl compounds such as a divinyl benzene, and a divinyl naphthalene; polyvinyl esters of an aromatic polyvaleic carboxylic acid such as a divinyl phthalate, a divinyl isophthalate, a divinyl terephthalate, a divinyl homophthalate, a divinyl/trivinyl trimesate, a naphthalene divinyl dicarboxylate, and a biphenyl divinyl carboxylate; divinyl esters of a nitrogen containing aromatic compound such as a pyridine divinyl dicarboxylate; vinyl esters of an unsaturated heterocyclic compound carboxylic acid such as a vinyl pyromucate, a vinyl furan carboxylate, a pyrrole-2-vinyl carboxylate, and a vinyl thiophene carboxylate; (meth)acrylates of a straight chain polyhydric alcohol such as a butane diol methacrylate, a hexane diol acrylate, an octane diol methacrylate, a decane diol acrylate, and a dodecane diol methacrylate; (meth)acrylates of a branched, substituted polyhydric alcohol such as a neopentyl glycol dimethacrylate, and a 2-hydroxy, 1,3-diacryloxy propane; polyvinyl esters of a polyvaleic carboxylic acid such as a polyethylene glycol di(meth)acrylate, polypropylene polyethylene glycol di(meth)acrylates, a divinyl succinate, a divinyl fumarate, a vinyl/divinyl maleate, a divinyl diglycolate, a vinyl/divinyl itaconate, a divinyl acetone dicarboxylate, a divinyl glutarate, a 3,3′-divinyl thiodipropionate, a trans-divinyl/trivinyl aconitate, a divinyl adipate, a divinyl pimelate, a divinyl suberate, a divinyl azelate, a divinyl sebacate, a dodecane divinyl dioxide, and a divinyl brassilate, and the like.

Among these examples, (meth)acrylates of a straight chain polyhydric alcohol such as a butane diol methacrylate, a hexane diol acrylate, an octane diol methacrylate, a decane diol acrylate, and a dodecane diol methacrylate; (meth)acrylates of a branched, substituted polyhydric alcohol such as a neopentyl glycol dimethacrylate, and a 2-hydroxy, 1,3-diacryloxy propane; and polyvinyl esters of a polyvaleic carboxylic acid such as a polyethylene glycol di(meth)acrylate, polypropylene polyethylene glycol di(meth)acrylates, a divinyl succinate, a divinyl fumarate, a vinyl/divinyl maleate, a divinyl diglycolate, a vinyl/divinyl itaconate, a divinyl acetone dicarboxylate, a divinyl glutarate, a 3,3′-divinyl thiodipropionate, a trans-divinyl/trivinyl aconitate, a divinyl adipate, a divinyl pimelate, a divinyl suberate, a divinyl azelate, a divinyl sebacate, a dodecane divinyl dioxide, and a divinyl brassilate advantageous for the glossiness control easiness and the reaction stability are preferable. In particular, (meth)acrylates of a straight chain polyhydric alcohol such as a butane diol methacrylate, a hexane diol acrylate, an octane diol methacrylate, a decane diol acrylate, and a dodecane diol methacrylate; (meth)acrylates of a branched, substituted polyhydric alcohol such as a neopentyl glycol dimethacrylate, and a 2-hydroxy, 1,3-diacryloxy propane; a polyethylene glycol di(meth)acrylate, and polypropylene polyethylene glycol di(meth)acrylates are preferable.

Moreover, the cross-linking agents may be used alone or in a combination of two or more kinds.

The binding agent according to the invention is synthesized by radical polymerization of the polymerizable monomer. A radical polymerization initiating agent used for the radical polymerization reaction is not particularly limited. However, the examples thereof include peroxides such as a hydrogen peroxide, an acetyl peroxide, a cumyl peroxide, a tert-butyl peroxide, a propionyl peroxide, a benzoyl peroxide, a chlorobenzoyl peroxide, a dichlorobenzoyl peroxide, a bromo methyl benzoyl peroxide, a lauroyl peroxide, an ammonium persulfate, a sodium persulfate, a potassium persulfate, a peroxy diisopropyl carbonate, a tetralin hydro peroxide, a 1-phenyl-2-methyl propyl-1-hydro peroxide, a pertriphenyl acetic acid-tert-butyl hydro peroxide, a a performic acid tert-butyl, a peracetic acid tert-butyl, a perbenzoic acid tert-butyl, a perphenyl acetic acid tert-butyl, a permethoxy acetic acid tert-butyl, and a perN-(3-toluyl) carbamic acid tert-butyl; azo compounds such as a 2,2′-azobis propane, a 2,2′-dichloro-2,2′-azobis propane, a 1,1′-azo (methyl ethyl) diacetate, a 2,2′-azobis (2-amidino propane) hydrochloride, a 2,2′-azobis (2-amidino propane) nitrate, a 2,2′-azobis isobutene, a 2,2′-azobis isobutyl amide, a 2,2′-azobis isobutylo nitrile, a 2,2′-azobis-2-methyl methyl propionate, a 2,2′-dichloro-2,2′-azobis butane, a 2,2′-azobis-2-methyl butylo nitrile, a 2,2′-azobis dimethyl isobutyrate, a 1,1′-azobis (1-methyl butylo nitrile-3-sodium sulfonate), a 2-(4-methyl phenyl azo)-2-methyl marono dinitrile, a 4,4′-azobis-4-cyano valeric acid, a 3,5-dihydroxy methyl phenyl azo-2-methyl marono dinitrile, a 2-(4-bromo phenyl azo)-2-allyl marono dinitrile, a 2,2′-azobis-2-methyl valero nitrile, a 4,4′-azobis-4-dimethyl cyanovalerate, a 2,2′-azobis-2,4-dimethyl valero nitrile, a 1,1′-azobis cyclo hexane nitrile, a 2,2′-azobis-2-propyl butylo nitrile, a 1,1′-azobis-1-chloro phenyl ethane, a 1,1′-azobis-1-cyclo hexane carbonitrile, a 1,1′-azobis-1-cyclo heptane nitrile, a 1,1′-azobis-1-phenyl ethane, a 1,1′-azobis cumene, a 4-nitro phenyl azo benzyl ethyl cyanovalerate, a phenyl azo diphenyl methane, a phenyl azo triphenyl methane, a 4-nitro phenyl azo triphenyl methane, a 1,1-azobis-1,2-diphenyl ethane, a poly(bisphenol A-4,4′-azobis-4-cyano pentanoate), and a poly(tetraethylene glycol-2,2′-azobis isobutylate); a 1,4-bis (pentaethylene)-2-tetrazene, a 1,4-dimethoxy carbonyl-1,4-diphenyl-2-tetrazene, and the like.

Among these examples, peroxides such as a hydrogen peroxide, an acetyl peroxide, a cumyl peroxide, a tert-butyl peroxide, a propionyl peroxide, a benzoyl peroxide, a chlorobenzoyl peroxide, a dichlorobenzoyl peroxide, a bromo methyl benzoyl peroxide, a lauroyl peroxide, an ammonium persulfate, a sodium persulfate, a potassium persulfate, a peroxy diisopropyl carbonate, a tetralin hydro peroxide, a 1-phenyl-2-methyl propyl-1-hydro peroxide, a pertriphenyl acetic acid-tert-butyl hydro peroxide, a a performic acid tert-butyl, a peracetic acid tert-butyl, a perbenzoic acid tert-butyl, a perphenyl acetic acid tert-butyl, a permethoxy acetic acid tert-butyl, and a perN-(3-toluyl) carbamic acid tert-butyl are preferable due to the advantage for the reaction control easiness at the time of polymerization. In particular, a hydrogen peroxide, an acetyl peroxide, a cumyl peroxide, a tert-butyl peroxide, a propionyl peroxide, a benzoyl peroxide, a chlorobenzoyl peroxide, a dichlorobenzoyl peroxide, a bromo methyl benzoyl peroxide, a lauroyl peroxide, an ammonium persulfate, a sodium persulfate, a potassium persulfate, and a peroxy diisopropyl carbonate are preferable.

It is preferable that the coloring agent used in a toner of the invention contains at least one selected from the group consisting of a cyan pigment, a magenta pigment and a yellow pigment. The pigments may be used alone or as a mixture of two or more kinds of the similar type pigments. Moreover, two or more kinds of different type pigments may be used as a mixture.

The specific examples of the coloring agent include various kinds of pigments such as a chrome yellow, a hanza yellow, a benzidine yellow, a surene yellow, a quinoline yellow, a permanent orange GTR, a pyrazolone orange, a Balkan orange, a watch young red, a permanent red, a brilliant carmine 3B, a brilliant carmine 6B, a Dupont oil red, a pyrazolone red, a rhodamine B rake, a rake red C, a rose Bengal, an aniline blue, a ultra marine blue, a chalcoyl blue, a methylene blue chloride, a phthalocyanine blue, a phthalocyanine green, and a malachite green oxalate; various kinds of dyes such as an acridine based one, a xanthene based one, an azo based one, a benzoquinone based one, an azine based one, an anthraquinone based one, a dioxadine based one, a thiadine based one, an azomethyne based one, an indigo based one, a thio indigo based one, a phthalocyanine based one, an aniline black based one, a polymethyne based one, a triphenyl methane based one, a diphenyl methane based one, a thiazol based one, and a xanthene based one; and the like.

Furthermore, a black pigment or a dye such as a carbon black may be added to the coloring agents to the extent not to lower the transparency.

A mold releasing agent may be added to the toner of the invention. By adding the mold releasing agent, the toner can be released from a heating member without the need of coating an image fixing device with a silicone oil. At the same time, since an oil supplying machine can be eliminated from the image fixing device, miniaturization and a light weight can be achieved.

At the time of forming toner particles by the emulsion polymerization aggregating method or suspension polymerization method, since a mold releasing agent, which in general is hydrophobic, is taken into the aggregated particles at the time of aggregation and fusion in the emulsion polymerization aggregating method, or at the time of dispersion in the suspension polymerization method so that it can hardly exist on the surface. Moreover, since a large amount of carboxyl groups having a high Tg are presumed to exist on the surface of the aggregated particles as mentioned above, it is easy to form aggregated particles. In contrast, according to the conventional kneading pulverization method, since a large amount of mold releasing agent components exist on the particle surface at the time of polymerization, there have been problems such as easy generation of adhesion between the particles with each other.

The specific examples of the mold releasing agent include low molecular weight polyolefins such as a polyethylene, a polypropylene and a polybutene; silicones having a softening point by heating; fatty acid amides such as an amide oleate, an amide eruciate, an amide ricinoleate, and an amide stearate; plant based waxes such as a carnauba wax, a rice wax, a canderira wax, a wood wax, and a hohoba oil; animal based waxes such as a honey wax; ore-petroleum based waxes such as a montan wax, an ozokerite, a ceresin, a paraffin wax, a micro crystalline wax, and a Fischer-Tropsch wax; ester waxes of a higher fatty acid and a higher alcohol such as a stearyl stearate, and a behenyl behenate; ester waxes of a higher fatty acid and a monovaleic or polyvaleic lower alcohol such as a butyl stearate, a propyl oleate, a glyceride monostearate, a glyceride distearate, and a pentaerythritol tetrabeheate; ester waxes of a higher fatty acid and a polyvaleic alcohol polymer such as a diethylene glycol monostearate, a dipropylene glycol distearate, a diglyceride distearate, and a triglyceride tetrastearate; sorbitan higher fatty acid ester waxes such as a sorbitan monostearate; cholesterol higher fatty acid ester waxes such as a cholesteryl stearate, and the like.

Among these examples, preferable examples include low molecular weight polyolefins such as a polyethylene, a polypropylene and a polybutene; plant based waxes such as a carnauba wax, a rice wax, a canderira wax, a wood wax, and a hohoba oil; ester waxes of a higher fatty acid and a higher alcohol such as a stearyl stearate, and a behenyl behenate; ester waxes of a higher fatty acid and a monovaleic or polyvaleic lower alcohol such as a butyl stearate, a propyl oleate, a glyceride monostearate, a glyceride distearate, and a pentaerythritol tetrabeheate; and ester waxes of a higher fatty acid and a polyvaleic alcohol polymer such as a diethylene glycol monostearate, a dipropylene glycol distearate, a diglyceride distearate, and a triglyceride tetrastearate are preferable due to the advantage in terms of the transparency of the fixed image, the color developing property and the color mixing property. In particular, low molecular weight polyolefins such as a polyethylene, a polypropylene and a polybutene, a carnauba wax, ester waxes of a higher fatty acid and a monovaleic or polyvaleic lower alcohol such as a butyl stearate, a propyl oleate, a glyceride monostearate, a glyceride distearate, and a pentaerythritol tetrabeheate, and the like.

When the binder resin, the coloring agent and the mold releasing agent are mixed, the amount of the mold releasing agent that is added is preferably 0.5 to 50% by mass, more preferably 1 to 30% by mass, and further preferably 5 to 15% by mass. If the amount is less than 0.5% by mass, the effect of adding the mold releasing agent cannot be achieved. If the amount is 50% by mass or more, not only are there results such as the charging property being easily influenced, the toner being easily destroyed inside the developing machine, the carrier of the mold releasing agent becoming spent, and the charge being easily lowered, but also, elution to the image surface at the time of fixation tends to be insufficient and the mold releasing agent tends to remain in the image, for example, when a color toner is used, so as to deteriorate the transparency. Thus, such an amount is not preferable.

The molecular weight of the mold releasing agent is preferably 300 to 2,000 in terms of the elution easiness to the toner surface at the time of contact with the heating member. More preferably, it is 500 to 1,500, and further preferably, 600 to 1,300.

In the case the molecular weight of the mold releasing agent is less than 300, due to the melting point decline of the mold releasing agent, elution of the mold releasing agent to the toner surface happens at an ordinary temperature resulting in a tendency for adhesion between the toner particles, and thus it is not preferable. Moreover, in the case the molecular weight is more than 2,000, due to difficulty of elution to the toner surface in the contact time with the heating member, the effect as the mold releasing agent can hardly be obtained, and thus it is not preferable.

The toner of the invention may include one or more kinds of carboxylic acids or derivatives thereof.

The carboxylic acid or derivative thereof is presumed to lower the aggregation force between the molecules of the binder resins. Therefore, the smoothness of the fixed image surface can be enhanced by the contact with the heating member.

The carboxylic acid or derivative thereof is not particularly limited as long as it has a Tg same as or higher than that of the toner and it is colorless or hypochromic. The specific examples include malonic acids such as a malonic acid, an allyl malonic acid, a cetyl malonic acid, an ethyl malonic acid, a diethyl malonic acid, a dimethyl malonic acid, a bromo malonic acid and a chloro malonic acid; succinic acids such as a succinic acid, an isosuccinic acid, an amino succinic acid, a diamino succinic acid, and an ethyl amino acid; glutaric acids such as a glutaric acid, a dimethyl glutaric acid, an α-methyl glutaric acid, a β-methyl glutaric acid, an α-ethyl glutaric acid and a β-ethyl glutaric acid; adipic acids; pimelic acids; suberic acids; azelaic acids; sebacic acids; dodecane dioxides, tridecane dioxides; aromatic carboxylic acids such as a biphenyl dicarboxylic acid and a naphthalene carboxylic acid; alkyl esters and amides thereof, and the like.

Among these examples, malonic acids such as a malonic acid, an allyl malonic acid, a cetyl malonic acid, an ethyl malonic acid, a diethyl malonic acid, a dimethyl malonic acid, a bromo malonic acid and a chloro malonic acid; succinic acids such as a succinic acid, an isosuccinic acid, an amino succinic acid, a diamino succinic acid, and an ethyl amino acid are preferable due to the advantege in terms of the smoothness improvement of the fixed image. In particular, succinic acids such as a succinic acid, an isosuccinic acid, an amino succinic acid, a diamino succinic acid, and an ethyl amino acid are preferable.

To the toner of the invention, according to the purpose, other components (particles) such as an internal additive, a charge controlling agent, inorganic particles, organic particles, a lubricating agent and a polishing material may be added.

The internal additive may be used by an amount to the extent not to hinder the charging property as a toner characteristic. The examples thereof include metals such as a ferrite, a magnetite, a reduced iron, a cobalt, a manganese, and a nickel, an alloy, a magnetic substance such as a compound containing these metals, and the like.

The charge controlling agent is not particularly limited. Particularly in the case a color toner is used, colorless one or a hypochromic one may be used preferably. The examples thereof include a quaternary ammonium salt compound, a nigrosine based compound, a dye made of a complex of an aluminum, an iron, a chromium, and the like, a triphenyl methane based pigment, and the like.

The examples of the inorganic particles include all the particles used ordinarily as an external additive for the toner surface such as a silica, a titania, a calcium carbonate, a magnesium carbonate, a tricalcium phosphate and a cerium oxide.

The examples of the organic particles include all the particles used ordinarily as an external additive for the toner surface such as a vinyl based resin, a polyester resin, and a silicone resin. These inorganic and organic particles can be used as a flowability auxiliary agent, a cleaning auxiliary agent, and the like.

The examples of the lubricating agent include fatty acid amides such as an ethylene amide bisstearate and an amide oleate, fatty acid metal salts such as a zinc stearate and a calcium stearate, and the like.

The examples of the polishing agent include the silica, alumina, cerium oxide, and the like.

The content of the coloring agent in the case of mixing the binder resin, the coloring agent and the mold releasing agent is preferably 50% by mass or less, and it is particularly preferably 2 to 40% by mass.

Moreover, the content of the other components may be to the extent not to hinder the purpose of the invention. In general, it is an extremely small amount. Specifically, it is preferably 0.01 to 5% by mass, and it is particularly preferably 0.5 to 2% by mass.

The examples of the dispersion medium for the resin particle dispersion, the coloring agent dispersion, the mold releasing agent dispersion, and the other components include a water based medium, and the like.

The examples of the water based medium include distilled water, ion exchange water, an alcohol, and the like. These can be used alone or in a combination of two or more kinds.

To the surface of the toner of the invention, inorganic particles of a silica, an alumina, a titania, a calcium carbonate, or the like, or resin particles of a vinyl based resin, a polyester resin, a silicone resin, or the like may be added while applying the shearing force in the dry state. These inorganic particles and the resin particles serve as an external additive such as a flowability auxiliary agent and a cleaning auxiliary agent.

The absolute value of the charge amount of the toner of the invention is preferably 10 to 40 μC/g, and it is more preferably 15 to 35 μC/g. In the case the charge amount is less than 10 μC/g, the background part pollution can easily be generated, and in the case it is more than 40 μC/g, the image density decline can easily be generated.

Moreover, the ratio between the charge amount in the summer season and the charge amount in the winter season is preferably 0.5 to 1.5, and it is more preferably 0.7 to 1.3. In the case the ratio is in the preferable range, the environment dependency of the toner is small, so that the excellent charging property stability can be provided, and thus it is preferable in the practical use.

The developing agent used in the image forming method of the invention is not particularly limited as long as it includes the toner of the invention, and thus it may have an optional component composition according to the purpose.

The developing agent is prepared as a one component type developing agent in the case the toner of the invention is used alone. Moreover, it is prepared as a two component type developing agent in the case the toner of the invention is used in combination with a carrier.

The carrier is not particularly limited so that known carriers can be used. For example, known carriers such as a resin covered carrier disclosed in JP-A Nos. 62-39879, 56-11461, or the like may be used.

The specific examples of the carrier include the following resin covered carriers. The examples of the core particles of the carrier include ordinarily used iron powders, a ferrite, a magnetite molded product, and the like. The average size thereof is about 30 to 200 μm.

The examples of the cover resin for the core particles include styrenes such as a styrene, a parachloro styrene, and an α-methyl styrene; α-methylene fatty acid monocarboxylic acids such as a methyl acrylate, an ethyl acrylate, an n-propyl acrylate, a lauryl acrylate, a 2-ethylhexyl acrylate, a methyl methacrylate, an n-propyl methacrylate, a lauryl methacrylate, and a 2-ethyl hexyl methacrylate; nitrogen containing acrylics such as a dimethyl amino ethyl methacrylate; vinyl nitriles such as an acrylonitrile, and a methacrylonitrile; vinyl pyridines such as a 2-vinyl pyridine and a 4-vinyl pyridine; vinyl ethers such as a vinyl methyl ether and a vinyl isobutyl ether; vinyl ketones such as a vinyl methyl ketone, a vinyl ethyl ketone and a vinyl isopropenyl ketone; olefins such as an ethylene and a propylene; single polymers of a vinyl based fluorine-containing monomer such as a vinylidene fluoride, a tetrafluoro ethylene, and a hexafluoro ethylene, or copolymers of two or more kinds of the monomers; silicones such as a methyl silicone and a methyl phenyl silicone; polyesters containing a bisphenol, a glycol, and the like; an epoxy resin; a polyurethane resin; a polyamide resin; a cellulose resin; a polyether resin; a polycarbonate resin; and the like.

These resins may be used alone or in a combination of two or more kinds. The amount of the cover resin is preferably 0.1 to 10 parts by mass with respect to the core particles, and it is particularly preferably 0.5 to 3.0 parts by mass.

For the production of the carrier, a heating type kneader, a heating type Henschel mixer, a UM mixer, and the like can be used. Depending on the amount of the cover resin, a heating type fluidized bed, a heating type kiln, and the like can be used.

The mixing ratio of the toner of the invention and the carrier in the developing agent is not particularly limited, and thus it can be chosen according to the purpose.

It is preferable that the toner particles included in the toner of the invention are formed by the emulsion polymerization aggregating method or the suspension polymerization method. However, for example, the toner particles may also be formed without any problem by fusion and hetero aggregation of coloring resin particles, mold releasing agent encapsulated resin particles, and the like obtained by methods such as seed polymerization using a coloring agent or a mold releasing agent as the core.

Moreover, the surface area of the toner of the invention is not particularly limited, and thus any one in a range usable for an ordinary toner can be used. Specifically, it is 0.5 to 10 m²/g in the case the BET method is used, it is preferably 1.0 to 7 m²/g, and it is more preferably 1.2 to 5 m²/g.

An image forming method of the invention comprises an electrostatic latent image forming step of forming an electrostatic latent image on an image supporting member according to image information, an image forming step of visualizing the electrostatic latent image as a toner image with a developing agent, a transferring step of transferring the toner image on a transfer member, and a fixing step of fixing by inserting the transfer member with the toner image transferred between a heating member and a pressuring member of an image fixing device, wherein the developing agent contains the toner of the invention.

The above-mentioned steps of the image forming method of the invention are steps commonly executed such as those disclosed in JP-A Nos. 56-40868, 49-91231, and the like. The image forming method of the invention can be conducted using known image forming apparatus such as a copying machine and a facsimile machine.

Here, the image forming step is a step of forming a toner image by developing the electrostatic latent image by a developing agent layer provided on the surface of the developing agent supporting member of the developer. The developing agent layer is not particularly limited as long as it includes a developing agent containing the toner of the invention.

According to the image forming method of the invention, the surface glossiness of the toner image fixed on the transfer member via the fixing step depends on the contact time of the heating member and the transfer member, the contact pressure and the surface temperature of the heating member. According to the image forming method of the invention, for example, in the case a paper having a basis weight of 104 g/m² is used as the transfer member and the contact time with the heating member is set at 40 ms, the surface temperature of the heating member needs to be about 180° C.

The image forming apparatus used for the image forming method of the invention comprises a heating member and a pressuring member disposed in contact with the surface of the heating member for fixing the toner image by inserting the transfer member with the toner image transferred between the heating member and pressuring member.

The heating member comprising a hollow metal roll may be provided with a heat-generating member such as a halogen lamp inside. Moreover, as the heating member, a heating roll for generating heat by disposing a resistor with a high electric resistance in the vicinity of the surface of the metal roll and energizing the same may be used.

As the pressuring member, a metal roll with the surface covered with a resin may be used. Furthermore, the pressuring member itself may generate heat by providing a heat-generating member inside or on the surface of the pressuring member. In this case, since the temperature decline on the surface of the heating member by heat absorption by the transfer member at the time of inserting the transfer member can be reduced, the image quality decline of the fixed toner image can be restrained. Moreover, an endless belt made of a resin film can be used as the pressuring member. In the case the endless belt is used, the contact area of the heating member and the pressuring member may increases so as to achieve a high speed toner image fixation, and thus it is preferable.

It is preferable that the surface of the heating member is coated with a fluorine-containing resin having a surface energy lower than that of the melted toner in order to obtain the homogeneity of the glossiness on the surface of the fixed toner image.

The specific examples of the fluorine-containing resin include single polymers or copolymers of a plurality of fluorine-containing polymerizable monomers such as an ethylene fluoride, a vinylidene fluoride, a trifluoro ethylene, a tetrafluoro ethylene, a perfluoro butyl ethyl acrylate, and a perfluoro hexyl ethyl acrylate. Furthermore, it may be a copolymer of the fluorine-containing polymerizable monomer and styrenes such as a styrene, parachloro styrene and an α-methyl styrene; esters having a vinyl group such as a methyl acrylate, an ethyl acrylate, an n-propyl acrylate, an n-butyl acrylate, a lauryl acrylate, a 2-ethyl hexyl acrylate, a methyl methacrylate, an ethyl methacrylate, an n-propyl methacrylate, a lauryl methacrylate and a 2-ethyl hexyl methacrylate; vinyl nitriles such as an acrylonitrile and a methacrylonitrile; vinyl ethers such as a vinyl methyl ether and a vinyl isobutyl ether; a vinyl methyl ketone, a vinyl ethyl ketone and a vinyl isopropenyl ketones; and olefins such as an ethylene, a propylene, a butadiene and an isoprene.

Moreover, a mixture of a resin containing fluorine and a resin not containing fluorine can be used as well.

In addition thereto, silicones such as a methyl silicone and a phenyl silicone can also be used.

Among these examples, esters having a vinyl group such as a methyl acrylate, an ethyl acrylate, an n-propyl acrylate, an n-butyl acrylate, a lauryl acrylate, a 2-ethyl hexyl acrylate, a methyl methacrylate, an ethyl methacrylate, an n-propyl methacrylate, a lauryl methacrylate and a 2-ethyl hexyl methacrylate are preferable due to the advantage in terms of the copolymerization easiness with the fluorine resin. In particular, a methyl acrylate, an ethyl acrylate, a methyl methacrylate, and an ethyl methacrylate are preferable.

By using a paper having a basis weight of 104±5 g/m² as the transfer member, the fixed image can be provided with a high-quality feeling. Furthermore, owing to glossiness of the image, a high quality-feeling can be further provided.

As to the paper, the arithmetic mean roughness Ra of the paper surface represented by the JIS B 0601-94 is preferably 0.6 μm or less in order to obtain the glossiness of the image. Although a paper without coating may be used, it is preferable to use a paper coated with a resin such as a polyester on the surface to obtain glossiness.

The arithmetic mean roughness Ra of the paper surface can be measured easily by a method such as the JIS B 0651-76, the JIS B 0652-73, and the like.

### EXAMPLES

Hereinafter, examples of the invention will be explained, but the invention is not limited to these examples.

In the following description, the “part” denotes the part by mass. Moreover, the average particle size of the toner particles was measured using a Colter counter (produced by Colter Corp., TA2 type). The resin molecular weight and the resin molecular weight distribution of the binder resin particles and the toner particles were measured using a gel permeation chromatography (produced by Tosoh Corp., HLC-8120GPC). The shown weight average molecular weight Mw was obtained using a tetra hydro furan as the solvent and converted by a styrene. Moreover, the glass transition point of the resin in the resin particles and the toner particles was measured using a differential scanning calorimeter (produced by Shimadzu Corp., DSC-50) under a condition of a temperature rise of a 3° C./minute.

Moreover, the molecular weight of the mold releasing agent was measured using a gel permeation chromatography (produced by Tosoh Corp., HLC-8120GPC), a GMH-HT 30 cm twin type column (produced by Tosoh Corp), and a toluene (produced by Junsei Chemical Co. Ltd.) as the solvent in the 130° C. temperature and 1.5 ml/minute flow rate condition.

—Preparation of the Resin Particle Dispersion (1)—

| | |
|---|---|
| Styrene | 56.2 parts |
| Butyl acrylate | 24.1 parts |
| Acrylic acid | 2.2 parts |
| Divinyl adipate | 1.0 part |
| Dodecyl mercaptan | 1.4 parts |

(So far produced by Wako Pure Chemical Industries, Ltd.)

An oil phase prepared by mixing and dissolving the above, and a water phase prepared by dissolving 2.0 parts of the New Lex R (produced by NOF Corp.) in 114 parts of ion exchange water were mixed and dispersed in a flask. After further mixing slowly for 10 minutes, 1.5 parts of an ammonium persulfate (produced by Wako Pure Chemical Industries, Ltd.) dissolved in 50 parts of ion exchange water was introduced thereto. After sufficient nitrogen substitution, the content was heated up to 70° C. in an oil bath while stirring the inside of the flask, and the emulsion polymerization was continued for 6 hours. Thereafter, the reaction liquid was cooled down to the room temperature so as to prepare a resin particle dispersion (1). A part of the resin particle dispersion (1) was left on an 80° C. oven for removing the moisture content for measurement of the characteristics of the residual product. It was found out that the Mw was 28,000 and the Tg was 53° C.

—Preparation of the Resin Particle Dispersion (2)—

| | |
|---|---|
| Styrene | 62.7 parts |
| Butyl acrylate | 16.7 parts |
| Maleic acid | 2.4 parts |
| Divinyl benzene | 0.3 part |
| Dodecyl mercaptan | 0.6 part |

(So far produced by Wako Pure Chemical Industries, Ltd.)

An oil phase prepared by mixing and dissolving the above, and a water phase prepared by dissolving 2.0 parts of the Pionine A-45-D (produced by Takemoto Oil & Fat Co. Ltd.) in 114 parts of ion exchange water were mixed and dispersed in a flask. After further mixing slowly for 10 minutes, 1.3 parts of an ammonium persulfate (produced by Wako Pure Chemical Industries, Ltd.) dissolved in 50 parts of ion exchange water was introduced thereto. After sufficient nitrogen substitution, the content was heated up to 70° C. in an oil bath while stirring the inside of the flask, and the emulsion polymerization was continued for 6 hours. Thereafter, the reaction liquid was cooled down to the room temperature so as to prepare a resin particle dispersion (2). A part of the resin particle dispersion (2) was left on an 80° C. oven for removing the moisture content for measurement of the characteristics of the residual product. It was found out that the Mw was 33,000 and the Tg was 54° C.

—Preparation of the Resin Particle Dispersion (3)—

| | |
|---|---|
| Styrene | 58.9 parts |
| Butyl acrylate | 16.6 parts |
| Acrylic acid | 1.9 parts |
| Maleic acid | 0.6 part |
| Divinyl adipate | 0.2 part |
| Dodecyl mercaptan | 1.2 part |

(So far produced by Wako Pure Chemical Industries, Ltd.)

An oil phase prepared by mixing and dissolving the above, and a water phase prepared by dissolving 1.8 parts of the New Lex R (produced by NOF Corp.) in 120 parts of ion exchange water were mixed and dispersed in a flask. After further mixing slowly for 10 minutes, 0.8 part of an ammonium persulfate (produced by Wako Pure Chemical Industries, Ltd.) dissolved in 50 parts of ion exchange water was introduced thereto. After sufficient nitrogen substitution, the content was heated up to 70° C. in an oil bath while stirring the inside of the flask, and the emulsion polymerization was continued for 6 hours. Thereafter, the reaction liquid was cooled down to the room temperature so as to prepare a resin particle dispersion (3). A part of the resin particle dispersion (3) was left on an 80° C. oven for removing the moisture content for measurement of the characteristics of the residual product. It was found out that the Mw was 25,000 and the Tg was 51° C.

—Preparation of the Resin Particle Dispersion (4)—

| | |
|---|---|
| Styrene | 56.2 parts |
| Butyl acrylate | 24.1 parts |
| Acrylic acid | 3.0 parts |
| Dodecyl mercaptan | 4.4 parts |

(So far produced by Wako Pure Chemical Industries, Ltd.)

An oil phase prepared by mixing and dissolving the above, and a water phase prepared by dissolving 2.0 parts of the New Lex R (produced by NOF Corp.) in 114 parts of ion exchange water were mixed and dispersed in a flask. After further mixing slowly for 10 minutes, 1.5 parts of an ammonium persulfate (produced by Wako Pure Chemical Industries, Ltd.) dissolved in 50 parts of ion exchange water was introduced thereto. After sufficient nitrogen substitution, the content was heated up to 70° C. in an oil bath while stirring the inside of the flask, and the emulsion polymerization was continued for 6 hours. Thereafter, the reaction liquid was cooled down to the room temperature so as to prepare a resin particle dispersion (4). A part of the resin particle dispersion (4) was left on an 80° C. oven for removing the moisture content for measurement of the characteristics of the residual product. It was found out that the Mw was 14,000 and the Tg was 48° C.

—Preparation of the Resin Particle Dispersion (5)—

| | |
|---|---|
| Styrene | 56.2 parts |
| Butyl acrylate | 24.1 parts |
| Acrylic acid | 3.0 parts |
| Dodecyl mercaptan | 0.5 part |

(So far produced by Wako Pure Chemical Industries, Ltd.)

An oil phase prepared by mixing and dissolving the above, and a water phase prepared by dissolving 2.0 parts of the New Lex R (produced by NOF Corp.) in 114 parts of ion exchange water were mixed and dispersed in a flask. After further mixing slowly for 10 minutes, 1.5 parts of an ammonium persulfate (produced by Wako Pure Chemical Industries, Ltd.) dissolved in 50 parts of ion exchange water was introduced thereto. After sufficient nitrogen substitution, the content was heated up to 70° C. in an oil bath while stirring the inside of the flask, and the emulsion polymerization was continued for 6 hours. Thereafter, the reaction liquid was cooled down to the room temperature so as to prepare a resin particle dispersion (5). A part of the resin particle dispersion (5) was left on a 80° C. oven for removing the moisture content for measurement of the characteristics of the residual product. It was found out that the Mw was 41,000 and the Tg was 55° C.

—Preparation of the Coloring Agent Dispersion (1)—

| | |
|---|---|
| Phthalocyanine pigment | 100 parts |
| (produced by Dainichiseika Color & Chemicals Mfg. Co., | |
| Ltd.: PV FAST BLUE) | |
| Anion surfactant | 2 parts |
| (produced by Dai-ichi Kogyo Seiyaku Co., Ltd.: Neogen RK) | |
| Ion exchange water | 250 parts |

After being mixed and dissolved, the materials were dispersed using a homogenizer (produced by IKA K.K.: Ultra Tarax) so as to prepare a coloring agent dispersion (1) with a coloring agent (phthalocyanine pigment) dispersed.

—Preparation of the Coloring Agent Dispersion (2)—

| | |
|---|---|
| Magenta pigment | 80 parts |
| (produced by Dainichiseika Color & Chemicals Mfg. Co., | |
| Ltd.: Pigment Red 122) | |
| Anion surfactant | 1.5 parts |
| (produced by Dai-ichi Kogyo Seiyaku Co., Ltd.: Neogen RK) | |
| Ion exchange water | 200 parts |

After being mixed and dissolved, the materials were dispersed using a homogenizer (produced by IKA K.K.: Ultra Tarax) so as to prepare a coloring agent dispersion (2) with a coloring agent (magenta pigment) dispersed.

—Preparation of the Coloring Agent Dispersion (3)—

| | |
|---|---|
| Yellow pigment | 60 parts |
| (produced by Clariant Japan K.K.: Pigment yellow 180) | |
| Anion surfactant | 2.0 parts |
| (produced by Dai-ichi Kogyo Seiyaku Co., Ltd.: Neogen RK) | |
| Ion exchange water | 250 parts |

After being mixed and dissolved, the materials were dispersed using a homogenizer (produced by IKA K.K.: Ultra Tarax) so as to prepare a coloring agent dispersion (3) with a coloring agent (yellow pigment) dispersed.

—Preparation of the Coloring Agent Dispersion (4)—

| | |
|---|---|
| Carbon black | 50 parts |
| (produced by Cabot Corp.: Legal 330) | |
| Anion surfactant | 1.0 part |
| (produced by Dai-ichi Kogyo Seiyaku Co., Ltd.: Neogen RK) | |
| Ion exchange water | 150 parts |

After being mixed and dissolved, the materials were dispersed using a homogenizer (produced by IKA K.K.: Ultra Tarax) so as to prepare a coloring agent dispersion (4) with a coloring agent (carbon black) dispersed.

—Preparation of the Mold Releasing Agent Dispersion (1)—

| | |
|---|---|
| Polyethylene wax | 80 parts |
| (produced by Nippon Seiro Co. Ltd.: weight average | |
| molecular weight: 400) | |
| Anion surfactant | 1.0 part |
| (produced by Dai-ichi Kogyo Seiyaku Co., Ltd.: Neogen RK) | |
| Ion exchange water | 120 parts |

After being mixed and dissolved at 95° C., the materials were dispersed using a homogenizer (produced by IKA K.K.: Ultra Tarax) so as to prepare a mold releasing agent dispersion (1) with a polyethylene wax dispersed.

—Preparation of the Mold Releasing Agent Dispersion (2)—

| | |
|---|---|
| Polyethylene wax | 80 parts |
| (produced by Nippon Seiro Co. Ltd.: weight average | |
| molecular weight: 1,000) | |
| Anion surfactant | 1.0 part |
| (produced by Dai-ichi Kogyo Seiyaku Co., Ltd.: | |
| Neogen RK) | |
| Ion exchange water | 120 parts |

After being mixed and dissolved at 95° C., the materials were dispersed using a homogenizer (produced by IKA K.K.: Ultra Tarax) so as to prepare a mold releasing agent dispersion (2) with a polyethylene wax dispersed.

—Preparation of the Mold Releasing Agent Dispersion (3)—

| | |
|---|---|
| Polyethylene wax | 80 parts |
| (produced by Nippon Seiro Co. Ltd.: weight average | |
| molecular weight: 1,800) | |
| Anion surfactant | 1.0 part |
| (produced by Dai-ichi Kogyo Seiyaku Co., Ltd.: | |
| Neogen RK) | |
| Ion exchange water | 120 parts |

After being mixed and dissolved at 95° C., the materials were dispersed using a homogenizer (produced by IKA K.K.: Ultra Tarax) so as to prepare a mold releasing agent dispersion (3) with a polyethylene wax dispersed.

—Preparation of the Mold Releasing Agent Dispersion (4)—

| | |
|---|---|
| Stearyl stearate | 80 parts |
| (produced by NOF Corp.: weight average molecular | |
| weight: 550) | |
| Anion surfactant | 1.0 part |
| (produced by Dai-ichi Kogyo Seiyaku Co., Ltd.: | |
| Neogen RK) | |
| Ion exchange water | 120 parts |

After being mixed and dissolved at 85° C., the materials were dispersed using a homogenizer (produced by IKA K.K. : Ultra Tarax) so as to prepare a mold releasing agent dispersion (4) with a polyethylene wax dispersed.

—Preparation of the Carboxylic Acid Dispersion (1)—

| | |
|---|---|
| Adipic acid | 20 parts |
| (produced by Wako Pure Chemical Industries, Ltd.) | |
| Anionic surfactant | 0.6 part |
| (produced by Dai-ichi Kogyo Seiyaku Co., Ltd.: Neogen RK) | |
| Ion exchange water | 40 parts |

After being mixed and dissolved at 80° C., the materials were dispersed using a homogenizer (produced by IKA K.K. : Ultra Tarax) so as to prepare a carboxylic acid dispersion (1) with a carboxylic acid derivative dispersed.

—Preparation of the Carboxylic Acid Dispersion (2)—

| | |
|---|---|
| Sebacic acid | 20 parts |
| (produced by Wako Pure Chemical Industries, Ltd.) | |
| Anionic surfactant | 0.6 part |
| (produced by Dai-ichi Kogyo Seiyaku Co., Ltd.: Neogen RK) | |
| Ion exchange water | 40 parts |

After being mixed and dissolved at 90° C., the materials were dispersed using a homogenizer (produced by IKA K.K.: Ultra Tarax) so as to prepare a carboxylic acid dispersion (2) with a carboxylic acid derivative dispersed.

(Developing Agent Production Method 1)

<Aggregation Step>

—Preparation of the Aggregated Particles—

| | |
|---|---|
| Resin particle dispersion (1) | 216.3 parts |
| Coloring agent dispersion (1) | 17.5 parts |
| Mold releasing agent particle dispersion (2) | 15.0 parts |
| Water glass | 25.0 parts |
| (produced by Nissan Chemical Industries, Ltd.: | |
| Snow Tex OS) | |
| Ion exchange water | 529.2 parts |
| Aluminum sulfate | 3 parts |
| (produced by Wako Pure Chemical Industries, Ltd.) | |

After storing the materials in a round stainless steel flask and dispersing the same using a homogenizer (produced by IKA K.K.: Ultra Tarax T50), pH in the container was adjusted to 3.5. Then, the resulting dispersion was heated to 47° C. while stirring in a heating oil bath. After being maintained at 47° C. for 30 minutes, the resulting dispersion was observed with an optical microscope so as to confirm formation of aggregated particles with an average particle size of about 5.1 μm. To the aggregated particle dispersion, 30 parts of the resin particle dispersion (1) were added slowly. Furthermore, after keeping the same heated and stirred at 48° C. for 20 minutes at the pH 3.5, it was observed with an optical microscope so as to confirm formation of the aggregated particles with an average particle size of about 5.4 μm.

<Fusing Step>

The pH of the aggregated particles was 3.6. Then, an aqueous solution in which a sodium peroxide (produced by Wako Pure Chemical Industries, Ltd.) was diluted to 0.5% by mass was added slowly for adjusting the pH to 6.6. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 5.5 μm and 28,000 Mw. By externally adding 2 parts of a colloidal silica (produced by Nippon Aerosil Co. Ltd., R972) to the 100 parts of the obtained toner particles, and mixing with a Henschel mixer, a toner (1) of the invention was obtained.

—Production of the Developing Agent—

100 parts of ferrite particles (produced by Powder Tech Corp., average particle size 50 μm) and 2.0 parts of a methacrylate resin (produced by Mitsubishi Rayon Co. Ltd., molecular weight of 85,000) were placed in a pressure type kneader together with 500 parts of a toluene. After stirring and mixing for 15 minutes at an ordinary temperature, the temperature thereof was raised up to 70° C. while mixing at a reduced pressure for removing the toluene. Then, by cooling and grading with a 105 μm shift, a ferrite carrier (resin covered carrier) was produced.

By mixing the ferrite carrier and the toner (1) of the invention, a two component type developing agent 1 having a 7% by mass toner concentration was produced.

(Developing Agent Production Method 2)

<Aggregation Step>

—Preparation of the Aggregated Particles—

| | |
|---|---|
| Resin particle dispersion (1) | 213.4 parts |
| Coloring agent dispersion (2) | 21.0 parts |
| Mold releasing agent particle dispersion (2) | 15.0 parts |
| Water glass | 25.0 parts |
| (produced by Nissan Chemical Industries, Ltd.: | |
| Snow Tex OS) | |
| Ion exchange water | 528.6 parts |
| Aluminum sulfate | 3 parts |
| (produced by Wako Pure Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 47° C. while stirring in a heating oil bath. After keeping the same at 47° C. for 30 minutes, it was observed with an optical microscope so as to confirm formation of the aggregated particles with an average particle size of about 5.0 μm. To the aggregated particle dispersion, 30 parts of the resin particle dispersion (1) were added slowly. Furthermore, after keeping the same heated and stirred at 48° C. for 20 minutes at the pH 3.5, it was observed with an optical microscope so as to confirm formation of the aggregated particles with an average particle size of about 5.3 μm.

<Fusing Step>

The pH of the aggregated particles was 3.6. Then, an aqueous solution in which a sodium peroxide (produced by Wako Pure Chemical Industries, Ltd.) was diluted to 0.5% by mass was added slowly for adjusting the pH to 6.6. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 5.3 μm and 28,000 Mw. By externally adding 2 parts of a colloidal silica (produced by Nippon Aerosil Co. Ltd., R972) to the 100 parts of the obtained toner particles, and mixing with a Henschel mixer, a toner (2) of the invention was obtained.

—Production of the Developing Agent—

By mixing the carrier produced in the Developing agent production method 1 and the toner (2) of the invention, a two component type developing agent 2 having a 7% by mass toner concentration was produced.

(Developing Agent Production Method 3)

<Aggregation Step>

—Preparation of the Aggregated Particles—

| | |
|---|---|
| Resin particle dispersion (1) | 219.3 parts |
| Coloring agent dispersion (3) | 20.6 parts |
| Mold releasing agent particle dispersion (2) | 15.0 parts |
| Water glass | 25.0 parts |
| (produced by Nissan Chemical Industries, Ltd.: | |
| Snow Tex OS) | |
| Ion exchange water | 523.1 parts |
| Aluminum sulfate | 3 parts |
| (produced by Wako Pure Chemical Industries, Ltd.) | |

After storing the materials in a round stainless steel flask and dispersing the same using a homogenizer (produced by IKA K.K. Ultra Tarax T50), pH in the container was adjusted to 3.5. Then, it was heated up to 47° C. while stirring in a heating oil bath. After keeping the same at 47° C. for 30 minutes, it was observed with an optical microscope so as to confirm formation of the aggregated particles with an average particle size of about 5.1 μm. To the aggregated particle dispersion, 30 parts of the resin particle dispersion (1) were added slowly. Furthermore, after keeping the same heated and stirred at 48° C. for 20 minutes at the pH 3.5, it was observed with an optical microscope so as to confirm formation of the aggregated particles with an average particle size of about 5.7 μm.

<Fusing Step>

The pH of the aggregated particles was 3.5. Then, an aqueous solution in which a sodium peroxide (produced by Wako Pure Chemical Industries, Ltd.) was diluted to 0.5% by mass was added slowly for adjusting the pH to 6.8. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 5.7 μm and 28,000 Mw. By externally adding 2 parts of a colloidal silica (produced by Nippon Aerosil Co. Ltd., R972) to the 100 parts of the obtained toner particles, and mixing with a Henschel mixer, a toner (3) of the invention was obtained.

—Production of the Developing Agent—

By mixing the carrier produced in the Developing agent production method 1 and the toner (3) of the invention, a two component type developing agent 3 having a 7% by mass toner concentration was produced.

(Developing Agent Production Method 4)

<Aggregation Step>

—Preparation of the Aggregated Particles—

| | |
|---|---|
| Resin particle dispersion (1) | 219.3 parts |
| Coloring agent dispersion (4) | 16.0 parts |
| Mold releasing agent particle dispersion (2) | 15.0 parts |
| Water glass | 25.0 parts |
| (produced by Nissan Chemical Industries, Ltd.: | |
| Snow Tex OS) | |
| Ion exchange water | 527.7 parts |
| Aluminum sulfate | 3 parts |
| (produced by Wako Pure Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 47° C. while stirring in a heating oil bath. After keeping the same at 47° C. for 30 minutes, it was observed with an optical microscope so as to confirm formation of the aggregated particles with an average particle size of about 4.9 μm. To the aggregated particle dispersion, 30 parts of the resin particle dispersion (1) were added slowly. Furthermore, after keeping the same heated and stirred at 47° C. for 20 minutes at the pH 3.5, it was observed with an optical microscope so as to confirm formation of the aggregated particles with an average particle size of about 5.5 μm.

<Fusing Step>

The pH of the aggregated particles was 3.5. Then, an aqueous solution in which a sodium peroxide (produced by Wako Pure Chemical Industries, Ltd.) was diluted to 0.5% by mass was added slowly for adjusting the pH to 6.8. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 5.7 μm and 28,000 Mw. By externally adding 2 parts of a colloidal silica (produced by Nippon Aerosil Co. Ltd., R972) to the 100 parts of the obtained toner particles, and mixing with a Henschel mixer, a toner (4) of the invention was obtained.

—Production of the Developing Agent—

By mixing the carrier produced in the Developing agent production method 1 and the toner (4) of the invention, a two component type developing agent 4 having a 7% by mass toner concentration was produced.

(Developing Agent Production Method 5)

<Aggregation Step>

—Preparation of the Aggregated Particles—

| | |
|---|---|
| Resin particle dispersion (1) | 216.3 parts |
| Coloring agent dispersion (1) | 17.5 parts |
| Mold releasing agent particle dispersion (1) | 15.0 parts |
| Water glass | 25.0 parts |
| (produced by Nissan Chemical Industries, Ltd.: | |
| Snow Tex OS) | |
| Ion exchange water | 529.2 parts |
| Aluminum chloride | 3 parts |
| (produced by Wako Pure Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 47° C. while stirring in a heating oil bath. After keeping the same at 47° C. for 30 minutes, it was observed with an optical microscope so as to confirm formation of the aggregated particles with an average particle size of about 5.5 μm. To the aggregated particle dispersion, 30 parts of the resin particle dispersion (1) were added slowly. Furthermore, after keeping the same heated and stirred at 47° C. for 20 minutes at the pH 3.5, it was observed with an optical microscope so as to confirm formation of the aggregated particles with an average particle size of about 5.8 μm.

<Fusing Step>

The pH of the aggregated particles was 3.5. Then, an aqueous solution in which a sodium peroxide (produced by Wako Pure Chemical Industries, Ltd.) was diluted to 0.5% by mass was added slowly for adjusting the pH to 6.5. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 6.0 μm and 27,000 Mw. By externally adding 2 parts of a colloidal silica (produced by Nippon Aerosil Co. Ltd., R972) to the 100 parts of the obtained toner particles, and mixing with a Henschel mixer, a toner (5) of the invention was obtained.

—Production of the Developing Agent—

By mixing the carrier produced in the Developing agent production method 1 and the toner (5) of the invention, a two component type developing agent 5 having a 7% by mass toner concentration was produced.

(Developing Agent Production Method 6)

<Aggregation Step>

—Preparation of the Aggregated Particles—

| | |
|---|---|
| Resin particle dispersion (1) | 216.3 parts |
| Coloring agent dispersion (1) | 17.5 parts |
| Mold releasing agent particle dispersion (3) | 15.0 parts |
| Water glass | 25.0 parts |
| (produced by Nissan Chemical Industries, Ltd.: | |
| Snow Tex OS) | |
| Ion exchange water | 529.2 parts |
| Aluminum chloride | 3 parts |
| (produced by Wako Pure | |
| Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 47° C. while stirring in a heating oil bath. After keeping the same at 47° C. for 30 minutes, it was observed with an optical microscope so as to confirm formation of the aggregated particles with an average particle size of about 5.1 μm. To the aggregated particle dispersion, 30 parts of the resin particle dispersion (1) were added slowly. Furthermore, after keeping the same heated and stirred at 47° C. for 20 minutes at the pH 3.5, it was observed with an optical microscope so as to confirm formation of the aggregated particles with an average particle size of about 5.6 μm.

<Fusing Step>

The pH of the aggregated particles was 3.5. Then, an aqueous solution in which a sodium peroxide (produced by Wako Pure Chemical Industries, Ltd.) was diluted to 0.5% by mass was added slowly for adjusting the pH to 6.5. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 5.7 μm and 27,000 Mw. By externally adding 2 parts of a colloidal silica (produced by Nippon Aerosil Co. Ltd., R972) to the 100 parts of the obtained toner particles, and mixing with a Henschel mixer, a toner (6) of the invention was obtained.

—Production of the Developing Agent—

By mixing the carrier produced in the Developing agent production method 1 and the toner (6) of the invention, a two component type developing agent 6 having a 7% by mass toner concentration was produced.

(Developing Agent Production Method 7)

<Aggregation Step>

—Preparation of the Aggregated Particles—

| | |
|---|---|
| Resin particle dispersion (2) | 218.5 parts |
| Coloring agent dispersion (1) | 17.5 parts |
| Mold releasing agent particle dispersion (2) | 15.0 parts |
| Water glass | 25.0 parts |
| (produced by Nissan Chemical Industries, Ltd.: | |
| Snow Tex OS) | |
| Ion exchange water | 527.0 parts |
| Calcium carbonate | 7 parts |
| (produced by Wako Pure | |
| Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 47° C. while stirring in a heating oil bath. After keeping the same at 47° C. for 30 minutes, it was observed with an optical microscope so as to confirm formation of the aggregated particles with an average particle size of about 5.2 μm. To the aggregated particle dispersion, 30 parts of the resin particle dispersion (2) were added slowly. Furthermore, after keeping the same heated and stirred at 47° C. for 20 minutes at the pH 3.5, it was observed with an optical microscope so as to confirm formation of the aggregated particles with an average particle size of about 5.8 μm.

<Fusing Step>

The pH of the aggregated particles was 3.6. Then, an aqueous solution in which a sodium peroxide (produced by Wako Pure Chemical Industries, Ltd.) was diluted to 0.5% by mass was added slowly for adjusting the pH to 6.9. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 6.0 μm and 32,000 Mw. By externally adding 2 parts of a colloidal silica (produced by Nippon Aerosil Co. Ltd., R972) to the 100 parts of the obtained toner particles, and mixing with a Henschel mixer, a toner (7) of the invention was obtained.

—Production of the Developing Agent—

By mixing the carrier produced in the Developing agent production method 1 and the toner (7) of the invention, a two component type developing agent 7 having a 7% by mass toner concentration was produced.

(Developing Agent Production Method 8)

<Aggregation Step>

—Preparation of the Aggregated Particles—

| | |
|---|---|
| Resin particle dispersion (3) | 235.8 parts |
| Coloring agent dispersion (1) | 17.5 parts |
| Mold releasing agent particle dispersion (2) | 15.0 parts |
| Water glass | 25.0 parts |
| (produced by Nissan Chemical Industries, Ltd.: | |
| Snow Tex OS) | |
| Ion exchange water | 509.7 parts |
| Calcium carbonate | 7 parts |
| (produced by Wako Pure | |
| Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 47° C. while stirring in a heating oil bath. After keeping the same at 47° C. for 30 minutes, it was observed with an optical microscope so as to confirm formation of the aggregated particles with an average particle size of about 5.8 μm. To the aggregated particle dispersion, 30 parts of the resin particle dispersion (3) were added slowly. Furthermore, after keeping the same heated and stirred at 47° C. for 20 minutes at the pH 3.5, it was observed with an optical microscope so as to confirm formation of the aggregated particles with an average particle size of about 6.5 μm.

<Fusing Step>

The pH of the aggregated particles was 3.6. Then, an aqueous solution in which a sodium peroxide (produced by Wako Pure Chemical Industries, Ltd.) was diluted to 0.5% by mass was added slowly for adjusting the pH to 6.9. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 6.7 μm and 22,000 Mw. By externally adding 2 parts of a colloidal silica (produced by Nippon Aerosil Co. Ltd., R972) to the 100 parts of the obtained toner particles, and mixing with a Henschel mixer, a toner (8) of the invention was obtained.

—Production of the Developing Agent—

By mixing the carrier produced in the Developing agent production method 1 and the toner (8) of the invention, a two component type developing agent 8 having a 7% by mass toner concentration was produced.

(Developing Agent Production Method 9)

<Aggregation Step>

—Preparation of the Aggregated Particles—

| | |
|---|---|
| Resin particle dispersion (1) | 215.5 parts |
| Coloring agent dispersion (1) | 17.5 parts |
| Mold releasing agent particle dispersion (2) | 15.0 parts |
| Carboxylic acid dispersion (1) | 0.9 part |
| Water glass | 25.0 parts |
| (produced by Nissan Chemical Industries, Ltd.: | |
| Snow Tex OS) | |
| Ion exchange water | 529.1 parts |
| Potassium chloride | 15 parts |
| (produced by Wako Pure | |
| Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 49° C. while stirring in a heating oil bath. After keeping the same at 49° C. for 30 minutes, it was observed with an optical microscope so as to confirm formation of the aggregated particles with an average particle size of about 6.1 μm. To the aggregated particle dispersion, 30 parts of the resin particle dispersion (1) were added slowly. Furthermore, after keeping the same heated and stirred at 49° C. for 20 minutes at the pH 3.5, it was observed with an optical microscope so as to confirm formation of the aggregated particles with an average particle size of about 6.8 μm.

<Fusing Step>

The pH of the aggregated particles was 3.7. Then, an aqueous solution in which a sodium peroxide (produced by Wako Pure Chemical Industries, Ltd.) was diluted to 0.5% by mass was added slowly for adjusting the pH to 7.2. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 6.7 μm and 28,000 Mw. By externally adding 2 parts of a colloidal silica (produced by Nippon Aerosil Co. Ltd., R972) to the 100 parts of the obtained toner particles, and mixing with a Henschel mixer, a toner (9) of the invention was obtained.

—Production of the Developing Agent—

By mixing the carrier produced in the Developing agent production method 1 and the toner (9) of the invention, a two component type developing agent 9 having a 7% by mass toner concentration was produced.

(Developing Agent Production Method 10)

<Aggregation Step>

—Preparation of the Aggregated Particles—

| | |
|---|---|
| Resin particle dispersion (1) | 215.5 parts |
| Coloring agent dispersion (1) | 17.5 parts |
| Mold releasing agent particle dispersion (2) | 15.0 parts |
| Carboxylic acid dispersion (2) | 0.9 part |
| Water glass | 25.0 parts |
| (produced by Nissan Chemical Industries, Ltd.: | |
| Snow Tex OS) | |
| Ion exchange water | 529.1 parts |
| Potassium chloride | 15 parts |
| (produced by Wako Pure | |
| Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 49° C. while stirring in a heating oil bath. After keeping the same at 49° C. for 30 minutes, it was observed with an optical microscope so as to confirm formation of the aggregated particles with an average particle size of about 6.5 μm. To the aggregated particle dispersion, 30 parts of the resin particle dispersion (1) were added slowly. Furthermore, after keeping the same heated and stirred at 49° C. for 20 minutes at the pH 3.5, it was observed with an optical microscope so as to confirm formation of the aggregated particles with an average particle size of about 6.9 μm.

<Fusing Step>

The pH of the aggregated particles was 3.6. Then, an aqueous solution in which a sodium peroxide (produced by Wako Pure Chemical Industries, Ltd.) was diluted to 0.5% by mass was added slowly for adjusting the pH to 7.2. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 7.1 μm and 28,000 Mw. By externally adding 2 parts of a colloidal silica (produced by Nippon Aerosil Co. Ltd., R972) to the 100 parts of the obtained toner particles, and mixing with a Henschel mixer, a toner (10) of the invention was obtained.

—Production of the Developing Agent—

By mixing the carrier produced in the Developing agent production method 1 and the toner (10) of the invention, a two component type developing agent 10 having a 7% by mass toner concentration was produced.

(Developing Agent Production Method 11)

<Aggregation Step>

—Preparation of the Aggregated Particles—

| | |
|---|---|
| Resin particle dispersion (1) | 216.3 parts |
| Coloring agent dispersion (1) | 17.5 parts |
| Mold releasing agent particle dispersion (4) | 15.0 parts |
| Water glass | 25.0 parts |
| (produced by Nissan Chemical Industries, Ltd.: | |
| Snow Tex OS) | |
| Ion exchange water | 529.2 parts |
| Aluminum sulfate | 3 parts |
| (produced by Wako Pure | |
| Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 46° C. while stirring in a heating oil bath. After keeping the same at 46° C. for 30 minutes, it was observed with an optical microscope so as to confirm formation of the aggregated particles with an average particle size of about 4.9 μm. To the aggregated particle dispersion, 30 parts of the resin particle dispersion (1) were added slowly. Furthermore, after keeping the same heated and stirred at 46° C. for 20 minutes at the pH 3.5, it was observed with an optical microscope so as to confirm formation of the aggregated particles with an average particle size of about 5.4 μm.

<Fusing Step>

The pH of the aggregated particles was 3.6. Then, an aqueous solution in which a sodium peroxide (produced by Wako Pure Chemical Industries, Ltd.) was diluted to 0.5% by mass was added slowly for adjusting the pH to 6.9. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 5.6 μm and 26,000 Mw. By externally adding 2 parts of a colloidal silica (produced by Nippon Aerosil Co. Ltd., R972) to the 100 parts of the obtained toner particles, and mixing with a Henschel mixer, a toner (11) of the invention was obtained.

—Production of the Developing Agent—

By mixing the carrier produced in the Developing agent production method 1 and the toner (11) of the invention, a two component type developing agent 11 having a 7% by mass toner concentration was produced.

(Developing Agent Production Method 12)

<Aggregation Step>

—Preparation of the Aggregated Particles—

| | |
|---|---|
| Resin particle dispersion (4) | 216.3 parts |
| Coloring agent dispersion (1) | 17.5 parts |
| Mold releasing agent particle dispersion (2) | 15.0 parts |
| Water glass | 25.0 parts |
| (produced by Nissan Chemical Industries, Ltd.: | |
| Snow Tex OS) | |
| Ion exchange water | 529.2 parts |
| Aluminum sulfate | 3 parts |
| (produced by Wako Pure | |
| Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 46° C. while stirring in a heating oil bath. After keeping the same at 44° C. for 30 minutes, it was observed with an optical microscope so as to confirm formation of the aggregated particles with an average particle size of about 5.0 μm. To the aggregated particle dispersion, 30 parts of the resin particle dispersion (4) were added slowly. Furthermore, after keeping the same heated and stirred at 44° C. for 20 minutes at the pH 3.5, it was observed with an optical microscope so as to confirm formation of the aggregated particles with an average particle size of about 5.6 μm.

<Fusing Step>

The pH of the aggregated particles was 3.6. Then, an aqueous solution in which a sodium peroxide (produced by Wako Pure Chemical Industries, Ltd.) was diluted to 0.5% by mass was added slowly for adjusting the pH to 7.0. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 5.9 μm and 15,000 Mw. By externally adding 2 parts of a colloidal silica (produced by Nippon Aerosil Co. Ltd., R972) to the 100 parts of the obtained toner particles, and mixing with a Henschel mixer, a toner (12) of the invention was obtained.

—Production of the Developing Agent—

By mixing the carrier produced in the Developing agent production method 1 and the toner (12) of the invention, a two component type developing agent 12 having a 7% by mass toner concentration was produced.

(Developing Agent Production Method 13)

<Aggregation Step>

—Preparation of the Aggregated Particles—

| | |
|---|---|
| Resin particle dispersion (5) | 216.3 parts |
| Coloring agent dispersion (1) | 17.5 parts |
| Mold releasing agent particle dispersion (2) | 15.0 parts |
| Water glass | 25.0 parts |
| (produced by Nissan Chemical Industries, Ltd.: | |
| Snow Tex OS) | |
| Ion exchange water | 529.2 parts |
| Aluminum sulfate | 3 parts |
| (produced by Wako Pure | |
| Chemical Industries, Ltd.) | |

After storing the materials in a round stainless steel flask and dispersing the same using a homogenizer (produced by IKA K.K.: Ultra Tarax T50), pH in the container was adjusted to 3.5. Then, it was heated up to 50° C. while stirring in a heating oil bath. After keeping the same at 50° C. for 30 minutes, it was observed with an optical microscope so as to confirm formation of the aggregated particles with an average particle size of about 5.1 μm. To the aggregated particle dispersion, 30 parts of the resin particle dispersion (5) were added slowly. Furthermore, after keeping the same heated and stirred at 44° C. for 20 minutes at the pH 3.5, it was observed with an optical microscope so as to confirm formation of the aggregated particles with an average particle size of about 5.5 μm.

<Fusing Step>

The pH of the aggregated particles was 3.6. Then, an aqueous solution in which a sodium peroxide (produced by Wako Pure Chemical Industries, Ltd.) was diluted to 0.5% by mass was added slowly for adjusting the pH to 7.0. While continuing the stirring, it was heated up to 97° C. and kept for 5 hours.

Thereafter, the pH in the container was adjusted to about 7. The reaction product was filtrated, washed with 500 parts of ion exchange water for 4 times, and dried using a vacuum drier so as to obtain toner particles.

<Evaluation>

The obtained toner particles had an average particle size of 5.7 μm and 40,000 Mw. By externally adding 2 parts of a colloidal silica (produced by Nippon Aerosil Co. Ltd., R972) to the 100 parts of the obtained toner particles, and mixing with a Henschel mixer, a toner (13) of the invention was obtained.

—Production of the Developing Agent—

By mixing the carrier produced in the Developing agent production method 1 and the toner (13) of the invention, a two component type developing agent 13 having a 7% by mass toner concentration was produced.

—Image Forming Method 1—

By adjusting the charging amount of a developing agent so as to form a solid portion of a 4.0 g/m² toner amount using a copying machine (produced by Fuji Xerox Co., Ltd. Vivace 400 modified machine), an unfixed image was obtained. Fixation for the obtained unfixed image was evaluated by an external fixation bench. The condition of the external fixation bench was as follows. That is, a heat roll was produced by attaching a 1 mm thickness baiton rubber on a φ40 mm metal roll, and furthermore attaching a sheet made of a polyfluoro ethylene-polyvinylidene fluoride copolymer thereon. A pressuring roll was produced by attaching a baiton rubber softer than said baiton rubber on a φ40 mm metal roll. The fixation bench was adjusted so as to have a 6 mm contact width between the pressuring roll and the heat roll, and the rate of the paper which passes between the pressuring roll and the heat roll was adjusted to be 150 mm/second. A heat-generating lamp, which was adjusted to cut off the heating power source in the case the temperature of the surface of the heat roll is more than a set temperature, was mounted inside of the heat roll.

At the time the heat roll surface reached the set temperature, a paper for forming the unfixed image was made pass through to form an image.

—Image Forming Method 2—

An image was formed in the same manner as in the image forming method 1 except in that a polyimide film was used instead of the pressuring roll, the polyimide film was fixed by a pressuring pad so as to have a 8 mm contact width with the heat roll, and the rate of the paper which passed between the polyimide film and the heat roll was adjusted to be 200 mm/second.

<Evaluation>

Fixation was conducted at the set temperature of 180° C. and 190° C. so as to measure the glossiness at each temperature. The glossiness unevenness in the fixed image at 190° C. was evaluated visually. A resin coated paper having a basis weight of 104 g/m² (Ra of the paper surface was 0.3 μm) was used as a paper.

### Example 1

In the example 1, a fixed image was produced according to the method shown in the image forming method 1 using the developing agent 1, and the evaluation was conducted.

### Examples 2 to 11

In the examples 2 to 11, the evaluation was conducted in the same manner as in the example 1 except in that the developing agents 2 to 11 were used.

### Comparative Example 1

In the comparative example 1, the evaluation was conducted in the same manner as in the example 1 except in that the developing agent 12 was used.

### Comparative Example 2

In the comparative example 2, the evaluation was conducted in the same manner as in the example 1 except in that the developing agent 13 was used.

### Example 12

In the example 12, a fixed image was produced according to the method shown in the image forming method 2 using the developing agent 1, and the evaluation was conducted.

### Examples 13 to 22

In the examples 13 to 22, the evaluation was conducted in the same manner as in the example 12 except in that the developing agents 2 to 11 were used.

### Comparative Example 3

In the comparative example 3, the evaluation was conducted in the same manner as in the example 12 except in that the developing agent 12 was used.

### Comparative example 4

In the comparative example 4, the evaluation was conducted in the same manner as in the example 12 except in that the developing agent 13 was used.

The image evaluation results for the examples 1 to 22 and the comparative examples 1 to 4 are shown in the table 1.

TABLE 1

| | | | Mold | | | | |
|---|---|---|---|---|---|---|---|
| | | | releasing | | | | Glossiness |
| | | Toner | agent | | | | unevenness |
| | | molecular | molecular | | | Gt (180)/ | (visual |
| | Developing agent | weight | weight | Gt (190) | Gt (180) | Gt (190) | inspection) |
| Example 1 | Developing agent 1 | 28000 | 1000 | 55% | 51% | 0.93 | Good |
| Example 2 | Developing agent 2 | 28000 | 1000 | 55% | 52% | 0.95 | Good |
| Example 3 | Developing agent 3 | 28000 | 1000 | 53% | 50% | 0.94 | Good |
| Example 4 | Developing agent 4 | 28000 | 1000 | 52% | 48% | 0.92 | Good |
| Example 5 | Developing agent 5 | 27000 | 400 | 44% | 36% | 0.82 | Good |
| Example 6 | Developing agent 6 | 27000 | 1800 | 41% | 36% | 0.88 | Good |
| Example 7 | Developing agent 7 | 32000 | 1000 | 37% | 31% | 0.83 | Good |
| Example 8 | Developing agent 8 | 22000 | 1000 | 62% | 72% | 1.16 | Good |
| Example 9 | Developing agent 9 | 28000 | 1000 | 66% | 66% | 1.00 | Good |
| Example 10 | Developing agent 10 | 28000 | 1000 | 65% | 70% | 1.08 | Good |
| Example 11 | Developing agent 11 | 26000 | 550 | 54% | 48% | 0.89 | Good |
| Example 12 | Developing agent 1 | 28000 | 1000 | 53% | 47% | 0.88 | Good |
| Example 13 | Developing agent 2 | 28000 | 1000 | 52% | 47% | 0.90 | Good |
| Example 14 | Developing agent 3 | 28000 | 1000 | 50% | 45% | 0.90 | Good |
| Example 15 | Developing agent 4 | 28000 | 1000 | 49% | 44% | 0.90 | Good |
| Example 16 | Developing agent 5 | 27000 | 400 | 39% | 33% | 0.85 | Good |
| Example 17 | Developing agent 6 | 27000 | 1800 | 40% | 34% | 0.85 | Good |
| Example 18 | Developing agent 7 | 32000 | 1000 | 36% | 29% | 0.81 | Good |
| Example 19 | Developing agent 8 | 22000 | 1000 | 60% | 66% | 1.10 | Good |
| Example 20 | Developing agent 9 | 28000 | 1000 | 64% | 65% | 1.02 | Good |
| Example 21 | Developing agent 10 | 28000 | 1000 | 63% | 69% | 1.10 | Good |
| Example 22 | Developing agent 11 | 26000 | 550 | 51% | 45% | 0.88 | Good |
| Comparative | Developing agent 12 | 15000 | 1000 | 41% | 61% | 1.49 | Generated |
| Example 1 | | | | | | | |
| Comparative | Developing agent 13 | 40000 | 1000 | 36% | 27% | 0.75 | Slightly existing |
| Example 2 | | | | | | | |
| Comparative | Developing agent 12 | 15000 | 1000 | 38% | 52% | 1.36 | Generated |
| Example 3 | | | | | | | |
| Comparative | Developing agent 13 | 40000 | 1000 | 32% | 21% | 0.66 | Slightly existing |
| Example 4 | | | | | | | |

From the results shown in the table 1, it is understood that an image with a good glossiness property can be formed according to the image forming method using the toner of the invention.

According to the invention, high glossiness of the fixed image can be maintained and generation of glossiness unevenness can be restrained, even when using a paper with a high basis weight and carrying out fixing at a high speed.

What is claimed is:

1. A toner comprising toner particles having a weight average molecular weight of 20,000 to 35,000 and containing a binder resin synthesized using a polymerizable monomer having a carboxyl group and a vinyl based unsaturated double bond, and a polymerizable monomer having a vinyl based unsaturated double bond,
wherein, upon using the toner to produce a 4.0 g/m² solid portion on a paper having a basis weight of 104 g/m², contacting the solid portion with a heating member of an image fixing device for 40 ms, and thereby fixing the solid portion on the paper, Gt(190)≧35% given that a glossiness of the solid portion when fixed at 190° C. according to JIS Z8741:97 is defined to be Gt(190), and 0.8≦Gt(180)/Gt(190)≦1.2 given that a glossiness of the solid portion when fixed at 180° C. is defined to be Gt(180).

2. A toner according to claim 1, wherein the weight average molecular weight of the toner particles is 25,000 to 32,000.

3. A toner according to claim 1, wherein the weight average molecular weight of the toner particles is 28,000 to 32,000.

4. A toner according to claim 1, wherein a content of said polymerizable monomer having a carboxyl group and a vinyl based unsaturated double bond in said binder resin is 0.3 to 10% by mass based on a total amount of the polymerizable monomers.

5. A toner according to claim 1, wherein a content of said polymerizable monomer having a carboxyl group and a vinyl based unsaturated double bond in said binder resin is 0.5 to 6% by mass based on a total amount of the polymerizable monomers.

6. A toner according to claim 1, wherein a content of said polymerizable monomer having a carboxyl group and a vinyl based unsaturated double bond in said binder resin is 1 to 3% by mass based on a total amount of the polymerizable monomers.

7. A toner according to claim 1, wherein an absolute value of a charging amount of the toner is 10 to 40 μC/g.

8. A toner according to claim 1, wherein an absolute value of a charging amount of the toner is 15 to 35 μC/g.

9. A toner according to claim 1, formed by an emulsion polymerization aggregating method.

10. A toner according to claim 1, formed by a suspension polymerization method.

11. A toner according to claim 1, containing one or more kinds of peeling agents.

12. A toner according to claim 11, wherein a molecular weight of said one or more kinds of peeling agents is 300 to 2,000.

13. A toner according to claim 11, wherein a molecular weight of said one or more kinds of peeling agents is 500 to 1,500.

14. A toner according to claim 11, wherein a molecular weight of said one or more kinds of peeling agents is 600 to 1,300.

15. A toner according to claim 1, containing a carboxylic acid or a derivative thereof.

16. An image forming method comprising the steps of:
forming an electrostatic latent image on an image supporting member according to image information;
visualizing the electrostatic latent image as a toner image with a developing agent;
transferring the toner image on a transfer member; and
fixing the toner image by inserting the transfer member with the toner image transferred thereon between a heating member and a pressuring member of an image fixing device,
wherein the developing agent contains a toner comprising toner particles having a weight average molecular weight of 20,000 to 35,000 and containing a binder resin synthesized using a polymerizable monomer having a carboxyl group and a vinyl based unsaturated double bond, and a polymerizable monomer having a vinyl based unsaturated double bond, wherein, upon using the toner to produce a 4.0 g/m² solid portion on a paper having a basis weight of 104 g/m², contacting the solid portion with a heating member of an image fixing device for 40 ms, and thereby fixing the solid portion on the paper, Gt(190)≧35% given that a glossiness of the solid portion when fixed at 190° C. according to JIS Z8741:97 is defined to be Gt(190), and 0.8≦Gt(180)/Gt(190)≦1.2 given that a glossiness of the solid portion when fixed at 180° C. is defined to be Gt(180).

17. An image forming method according to claim 16, wherein a surface of said heating member is coated with a fluorine-containing resin.

18. An image forming method according to claim 16, wherein said pressuring member comprises a resin film.

19. An image forming method according to claim 16, wherein a surface temperature of said heating member is 170° C. or greater.

20. An image forming method according to claim 16, wherein a surface temperature of said heating member is 180° C. or greater.

21. An image forming method according to claim 16, wherein said transfer member is a paper having a basis weight of 104±5 g/m².

22. An image forming apparatus comprising a device for visualizing an electrostatic latent image as a toner image with a developing agent, wherein said developing agent contains a toner comprising toner particles having a weight average molecular weight of 20,000 to 35,000 and containing a binder resin synthesized using a polymerizable monomer having a carboxyl group and a vinyl based unsaturated double bond, and a polymerizable monomer having a vinyl based unsaturated double bond, wherein, upon using the toner to produce a 4.0 g/m² solid portion on a paper having a basis weight of 104 g/m², contacting the solid portion with a heating member of an image fixing device for 40 ms, and thereby fixing the solid portion on the paper, Gt(190)≧35% given that a glossiness of the solid portion when fixed at 190° C. according to JIS Z8741:97 is defined to be Gt(190), and 0.8≦Gt(180)/Gt(190)≦1.2 given that a glossiness of the solid portion when fixed at 180° C. is defined to be Gt(180).
